(19) United States
(12) Patent Application Publication
(10) Pub. No.: US 2005/0125726 A1
(43) Pub. Date: Jun. 9, 2005

(54) Methods and systems for processing digital photography books

(76) Inventors: Gregory W. Harper, New York, NY (US); Sam N. Edge, Reno, NV (US); Mithila Raman, Pleasanton, CA (US)

Correspondence Address: FINNEGAN, HENDERSON, FARABOW,;GARRETT & DUNNER, L.L.P., 1300 I Street, NW, Washington, DC, 20005-3315, US

(21) Appl. No.: 10/917,352

(22) Filed: Aug. 13, 2004

Related U.S. Application Data
(60) Provisional application No. 60/495,141, filed on Aug. 15, 2003.

(51) Int. Cl. G06F 17/00

(52) U.S. Cl. 715/517; 358/1.1

(57) ABSTRACT

Methods and systems consistent with the present invention provide for producing a digital photography book. An interface receives book information corresponding to a digital photography book. A book document generating module selects a transform file for use in transforming the book information into a press-ready document, and creates the press-ready document from the book information using the selected transform file. The book information is treated as a single object during the creating. A verification module at a printing site attempts to verify the press-ready document. A press thereafter prints the press-ready document based on a determination that the press-ready document passed verification.

### RELATED APPLICATIONS

This application claims the benefit of U.S. Provisional Patent Application No. 60/495,141, entitled “SYSTEMS AND METHODS FOR PRODUCING DIGITAL PHOTOGRAPHY BOOKS,” which was filed on Aug. 15, 2003, the disclosure of which is hereby expressly incorporated herein by reference.

This application also relates to U.S. patent application Ser. No. ______, entitled “METHODS AND SYSTEMS FOR CREATING DIGITAL PHOTOGRAPHY BOOKS,” filed concurrently herewith, Attorney Docket No. 09101.0002, the disclosure of which is hereby expressly incorporated herein by reference.

### TECHNICAL FIELD

The present invention relates generally to data processing systems and, more particularly, to methods and systems for processing digital photography books prior to publishing.

### BACKGROUND

Several systems exist that enable people to collect digital pictures and make those digital pictures available for viewing by other people. For example, some systems allow a user to import digital pictures from a digital camera, scanner, file, or other source and post those pictures to a web site. The user may specify a list of e-mail addresses corresponding to people that should be granted access to the pictures. Thereafter, the people who have been granted access to the pictures may access the web site and view the pictures. Some of these systems enable the user to place the digital pictures in the format of an online photography book.

Recently, systems have become available that enable users to request that a digital photography book be printed. Printing may occur remotely, for example at a printing facility, which may then print the book and ship it to the requesting user. In such systems, for example, a user may import a number of digital pictures, decide where different pictures should be placed in the book, and edit the pictures, until the user is satisfied with the book. Thereafter, the user may order the book by purchasing it and sending data reflective of the book to the organization offering the digital photography book service. The organization may then arrange to have the book printed and send the printed book to the requesting user.

Previous systems for creating and printing digital photography books have several shortcomings. For example, previous systems do not accept orders for digital photography books from a plurality of clients that may use differing formats for digital photography books. Previous systems also do not verify, prior to printing, that a particular digital photography book will not cause a printing error (e.g., book is not properly printed).

### SUMMARY

Methods and systems consistent with the present invention produce a digital photography book. An interface receives book information corresponding to a digital photography book. A book document generating module selects a transform file for use in transforming the book information into a press-ready document, where the press-ready document corresponds to the digital photography book and includes, for example, crop marks, barcode information and customer order information. The book document generating module also creates the press-ready document from the book information using the selected transform file. The book information is treated as a single object during the creation.

Other methods and systems consistent with the present invention produce a digital photography book. An interface receives book information corresponding to a digital photography book. A book document generating module selects a transform file for use in transforming the book information into a press-ready document, and creates the press-ready document from the book information using the selected transform file. The book information is treated as a single object during the creation. A verification module at a printing site attempts to verify the press-ready document. A press thereafter prints the press-ready document based on a determination that the press-ready document passed verification.

Other methods and systems consistent with the present invention also produce a digital photography book. An interface receives book information corresponding to a digital photography book. A pre-verification module may then pre-verify the book information. A book document generating module operable determines a type of the book information if the book information passed pre-verification, and creates a press-ready document from the book information based on the determination.

Other methods and systems consistent with the present invention also produce a digital photography book. An interface receives book information corresponding to a digital photography book. A book document generating module is operable to determine a source of the book information, extract state information pertaining to the digital photography book from the book information based on the determination, create a book document from the book information using the extracted state information, and create a press-ready document from the book document using a transform file. The is for use in transforming book documents into press-ready documents.

Other methods and systems consistent with the present invention also produce a digital photography book. An interface receives book information corresponding to a digital photography book. A book document generating module may transform the book information into a first press-ready document. A verification module is operable to perform an error check on the first press-ready document, and create a new press-ready document from the first press-ready document based on a determination that the first press-ready document was not properly processed. A raster image processor module may process the first press-ready document for printing based on a determination that the first press-ready document passed the error check. A press is operable to print the new press-ready document.

### BRIEF DESCRIPTION OF THE DRAWINGS

The accompanying drawings, which are incorporated in and constitute a part of this specification, illustrate one embodiment of the invention and, together with the description, serve to explain the principles of the invention.

FIG. 1 is a diagram of an exemplary network environment in which features and aspects consistent with the principals of the present invention may be implemented;

FIG. 2A is a diagram of an exemplary bookmaker client consistent with the principals of the present invention;

FIG. 2B is a diagram of an exemplary partner client consistent with the principals of the present invention;

FIG. 3 is a diagram of exemplary pre-printing servers, consistent with the principals of the present invention;

FIG. 4 is a diagram of an exemplary printing site, consistent with the principals of the present invention;

FIG. 5 is a diagram of an exemplary commerce server consistent with the principals of the present invention;

FIG. 6 is a diagram of an exemplary web server consistent with the principals of the present invention;

FIG. 7 is a diagram of an exemplary OEM API consistent with the principals of the present invention;

FIG. 8 is a diagram of an exemplary pre-verification module consistent with the principals of the present invention;

FIG. 9 is a diagram of an exemplary book document generating module consistent with the principals of the present invention;

FIG. 10 is a diagram of an exemplary transporter module consistent with the principals of the present invention;

FIG. 11 is a diagram of an exemplary verification module consistent with the principals of the present invention;

FIG. 12 is a diagram of a flowchart of a method for producing a digital photography book in a manner consistent with the present invention;

FIG. 13A is a diagram of a flowchart of a method for processing book information received from a client in a manner consistent with the present invention;

FIG. 13B is a diagram of a flowchart of a method for processing book information received from a client, where the processing includes pre-verifying book information, in a manner consistent with the present invention;

FIG. 14 is a diagram of a flowchart of a method for pre-verifying book information in a manner consistent with the present invention;

FIG. 15 is a diagram of a flowchart of a method for generating a press-ready document in a manner consistent with the present invention;

FIG. 16 shows an exemplary transform file consistent with the present invention;

FIG. 17 shows another exemplary transform file consistent with the present invention;

FIG. 18 shows an exemplary page imposition for a simplex layout consistent with the present invention; and

FIG. 19 shows an exemplary page imposition for a duplex layout consistent with the present invention.

### DETAILED DESCRIPTION

Reference will now be made in detail to exemplary embodiments of the present invention, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Overview

Methods and systems consistent with the present invention enable production of digital photography books. A plurality of clients connected to a network are each operable to generate book information for digital photography books. Pre-printing servers are also connected to the network. The pre-printing servers include an interface operable to receive book information from one of the clients. The pre-printing servers also include a book document generating module operable to select a transform file for use in transforming book information into a press-ready document and create the press-ready document from the book information using the selected transform file. The book information is treated as a single object during the creation. A printing site is operable to receive the press-ready document from the pre-printing servers. The printing site includes a verification module operable to verify the press-ready document, and a press operable to print the press-ready document based on a determination that the press-ready document passed verification.

### Network Environment

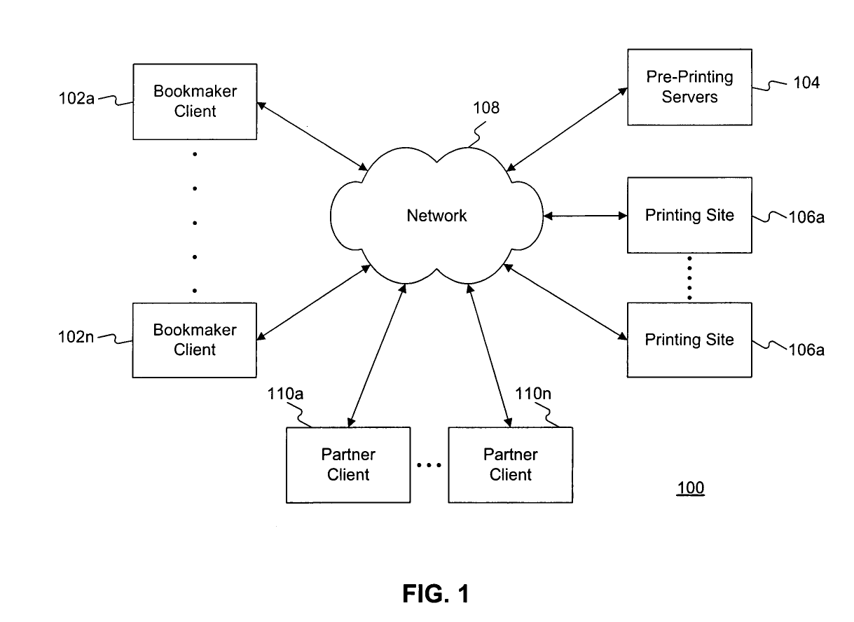

FIG. 1 is a block diagram of a network environment 100 in which features and aspects consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware. Network environment 100 may include bookmaker clients 102a-102n, pre-printing servers 104, printing sites 106a-106n, network 108, and partner clients 110a-110n.

Network 108 may be a shared, public, or private network and encompass a wide area or local area. Network 108 may be implemented through any suitable combination of wired and/or wireless communication networks. By way of example, network 108 may be implemented through a wide area network (WAN), local area network (LAN), an intranet and/or the Internet.

Printing sites 106a-106n may be operable to receive press-ready book information corresponding to a digital photography book from pre-printing servers 104, process that information as necessary, and print the digital photography book. Exemplary processing may include verifying that printing the digital photography book would not create an error condition and scheduling the printing of the digital photography book. Once a digital photography book has been printed, it may be shipped to the user that ordered it.

Pre-printing servers 104 may receive information corresponding to a digital photography book from a bookmaker client 102 or partner client 110 and process that information to prepare for printing of the digital photography book at one of printing sites 106a-106n. Exemplary processing may include pre-verifying that the information would not create an error condition, transforming the information into a press-ready format suitable for printing, and transporting the transformed information to a suitable printing site 106 at the appropriate time. In one embodiment, pre-printing servers 104 may also host a web site that is accessible by users of bookmaker clients 102a-102n and/or partner clients 110a-110n to download software for use in designing digital photography books.

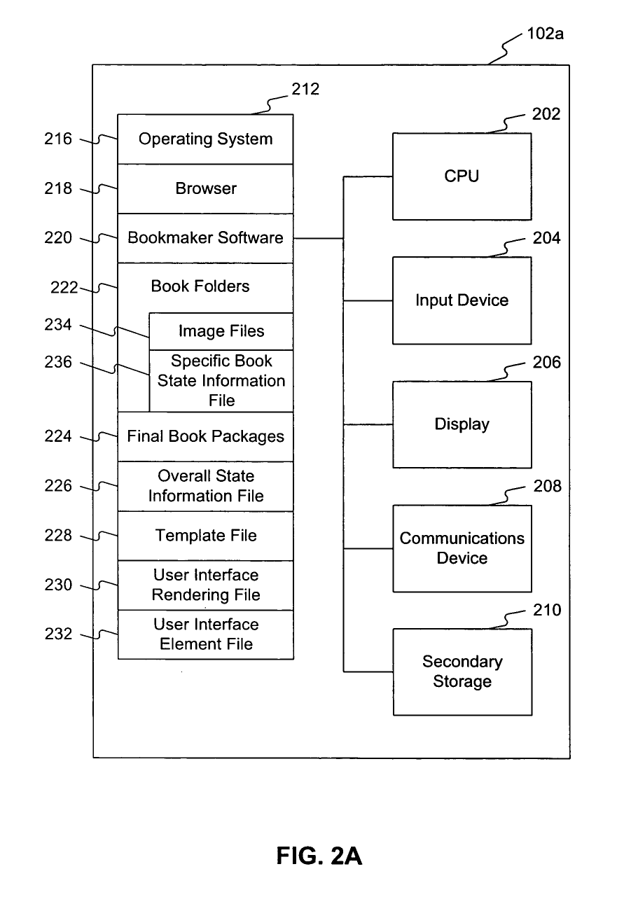

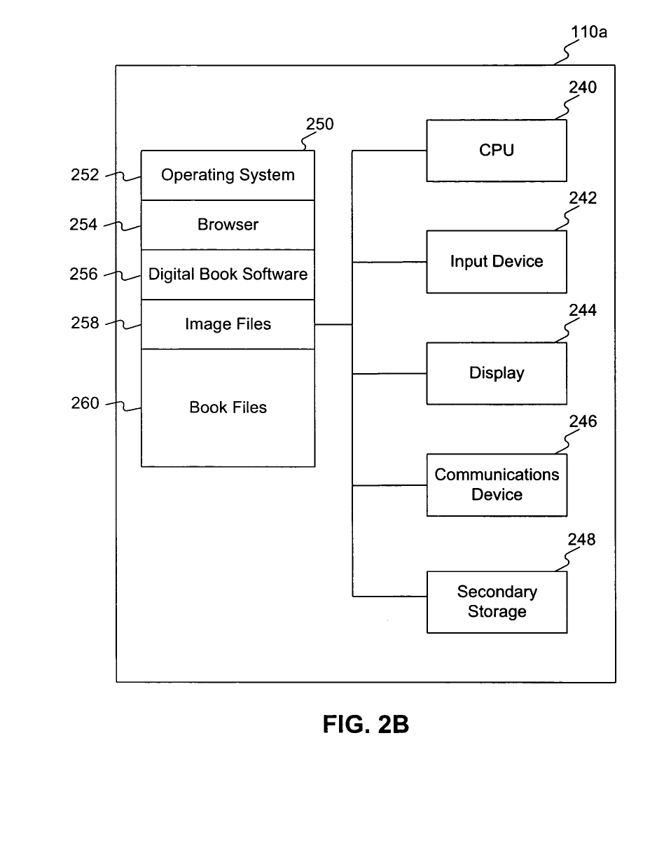

Bookmaker clients 102a-102n may be utilized by users to create digital photography books in various manners. For example, a user may use software resident on bookmaker client 102a to import a number of digital pictures from one or more sources and thereafter design a digital photography book using at least some of those digital pictures. The aforementioned software, for example, may be downloaded from a web site, purchased by the user at a retail store, or otherwise acquired by the user. In one embodiment, the software may be software provided by a business entity responsible for operating pre-printing servers 104. Therefore, the software may produce book information in a particular format, such as the format used for final book packages 224, discussed below with reference to FIG. 2A.

A digital photography book refers to a photography book, calendar, brochure, or other printed material that comprises a set of digital pictures. Potential sources for digital pictures may include, for example, a digital camera, a scanner, computer readable media (e.g., a compact disc, floppy disk, or digital versatile disc), locally stored files, the Internet, etc. After a digital photography book has been created (e.g., designed) using the software, the user may direct a client, such as client 102a, to upload information corresponding to the digital photography book to pre-printing servers 104 via network 108.

Partner clients 110a-110n may also be utilized by users to create digital photography books in various manners. For example, a user may use software resident on partner client 110a to import a number of digital pictures from one or more sources and thereafter design a digital photography book using at least some of those digital pictures. The aforementioned software, for example, may be downloaded from a web site, purchased by the user at a retail store, or otherwise acquired by the user. In one embodiment, the software may be software provided by a business entity that is business partners with the business entity responsible for operating pre-printing servers 104. The software may produce book information in a format other than the format used for final book packages 224. In this manner, a partner client 110 may utilize different software to create a digital photography book (e.g., software other than bookmaker software 220, described below with reference to FIG. 2A), but still be able to have pre-printing servers 104 and a printing site 106 work in conjunction to process and print the digital photography book.

FIG. 2A is a diagram of an exemplary bookmaker client consistent with the principals of the present invention. A bookmaker client, such as bookmaker client 102a, may include CPU 202, input device 204, display 206, communications device 208, secondary storage 210, and memory 212. Memory 212 may include operating system 216, browser 218, bookmaker software 220, book folders 222, final book packages 224, overall state information file 226, template file 228, user interface rendering file 230, and user interface element file 232. Each book folder 222 comprises a number of image files 234 and a specific state information file 236. The number of components in bookmaker client 102a is not limited to what is shown and other variations in the number of arrangements of components are possible, consistent with embodiments of the invention. One of ordinary skill in the art will appreciate that the other bookmaker clients depicted in FIG. 1 may be similar to bookmaker client 102a.

CPU 202 may be one or more known processing devices, such as a Pentium™ microprocessor manufactured by Intel Corporation. Control of bookmaker client 102a as well as data input by a user may be achieved through input device 204, which may comprise a keyboard, a pointer device, a stylus, a mouse, or a combination of these types of devices. Data output may be presented to a user of bookmaker client 102a through display 206 and/or another output device (such as a printer—not shown). Bookmaker client 102a may communicate with other computers using communications device 208, which may be a modem, network interface card, or other device for use in transmitting information from one computer to another. Secondary storage 210 may be one or more data storage mediums such as a hard drive, CD-ROM drive, DVD drive, floppy drive, etc.

Memory 212 may be one or more storage devices configured to store data used by CPU 202 to perform certain functions related to embodiments of the present invention. Memory 212 may be a magnetic, semiconductor, tape, or optical type of storage device. Software or data may be loaded into secondary storage 210 and/or memory 212 using, for example, a computer readable medium with software and/or other data that is read by secondary storage 210. Software and data may also be installed via network 108 and communications device 208.

As explained, memory 212 includes operating system 216, browser 218, bookmaker software 220, book folders 222, final book packages 224, overall state information file 226, template file 228, user interface rendering file 230, and user interface element file 232. Operating system 216 may be implemented using any suitable operating system, such as Windows 2000, Windows Me, Windows 98 Special Edition, Windows XP Home, or Windows XP professional, all manufactured by Microsoft Corporation. One of ordinary skill in the art will appreciate that other operating systems may also be used, including variations of the UNIX operating system such as LINUX, AIX™, and Solaris™.

Browser 218 may be implemented using any suitable browser, such as Internet Explorer, Netscape, etc. In one embodiment, for example, Internet Explorer 5.0, 5.5, or 6.0 or higher may be used to implement browser 218. One of ordinary skill in the art will appreciate that other browsers may also be used.

Bookmaker software 220 is configured to assist users in designing digital photography books in a manner consistent with the present invention. For example, a user of bookmaker client 102a may utilize bookmaker software 220 to import a number of digital pictures, organize those digital pictures, enhance the digital pictures in various ways, and build a digital photography book using the digital pictures. The user may also utilize bookmaker software 220 to purchase a digital photography book designed by the user, or to export information corresponding to a digital photography book to a remote or local location. After a digital photography book has been created (e.g., designed) and purchased using bookmaker software 220, the user may direct client 102a to upload information corresponding to the digital photography book to pre-printing servers 104 via network 108. In one embodiment, bookmaker software 220 may be a multi-threaded application that, for example, makes it unnecessary for a user to initiate a save operation by always keeping track of the current state of a book being designed. Thus, a user may be in the middle of importing photos, adding text captions, building a book, purchasing a book, etc., and can exit the application with full recovery to the previous state upon the next launch of bookmaker software 220.

Each book folder 222 may be a collection of files corresponding to a digital photography book being designed. For example, one book folder 222 may comprise a number of image files 234 and a specific book state information file 236. A set of image files 234 in a book folder 222 may correspond to digital pictures that a user has chosen to import for a digital photography book. In one embodiment, for each digital picture imported by the user, three image files 234 are created. A first image file may be a thumbnail image. A second image file may be a preview image. A third image file may be a full resolution image. The full resolution image has greater resolution than the preview image, which has greater resolution than the thumbnail image. Alternatively, three such image files 234 are created for each of some but not all of the imported digital pictures.

Generally, the preview image may be created to allow images to be quickly displayed in the largest resolution allowed by the specific display 206 being used without having to decompress the full resolution image. This allows many more images to be cached into memory without the need to load or unload photos from memory, disk, or other computer-readable medium. By way of example, a 5 mega pixel image in its compressed state may occupy approximately 2 MB of disk space, but in memory occupies approximately 15 MB of memory. This same image created as a preview image may occupy 258 kB of disk space at lossless compression and only 2.25 MB of memory space when decompressed. Thus, in this example by using preview images, approximately 7 times the number of images may be held in memory before the caching system needs to unload the image from memory to disk, as would be possible using full resolution images.

A specific book state information file 236 is a file created by bookmaker software 220 as soon as a user starts adding images to a digital photography book design. A specific book state information file 236, for example, keeps track of the current state of a digital photography book being designed including an identification of photos being imported, their directory structure information, file names and mapping information. A specific book state information file 236 may also include details on the template used to create the book, relationships between photos and photo molds (e.g., area on a page in which a photo may be placed), page locations, text and text molds (e.g., area on a page in which text may be placed), etc. In this manner, bookmaker software 220 may also determine the specific photos that correspond to a page, as well as how those photos have been enhanced, any caption information associated with those photos, what templates are assigned to a given page, page numbering information, footers, headers, etc. In one embodiment, a specific book state information file 236 may be implemented using a language such as XML (Extensible Markup Language). Further information on specific book state information file 236 may be found in U.S. application Ser. No. ______ (Attorney Docket No. 09101.0002), which is herein expressly incorporated by reference.

Final book packages 224 may comprise packages that are created by bookmaker software 220 when a user opts to either purchase or export a digital photography book. Book packages 224 may differ depending on whether the digital photography book was purchased or exported. In one embodiment, final book packages 224 are implemented using Direct Internet Message Encapsulation (DIME) packages.

Generally, DIME is a lightweight, binary message format that can be used to encapsulate one or more application-defined payloads of arbitrary type and size into a single message construct. Each payload is described by a type, a length, and an optional identifier. Both URI (Uniform Resource Identifiers) and MIME (Multipurpose Internet Mail Extensions) media type constructs are supported as type identifiers. The optional payload identifier is a URI that enables cross-referencing between payloads. DIME payloads may include nested DIME messages or chains of linked chunks of unknown length at the time the data is generated.

DIME may be used as the format for final book packages 224 in order to encapsulate all book assets into a single payload container for ease of transfer and to make the transfer of these assets straight forward for the purposes of uploading to pre-printing servers 104 and additionally to re-establish upload connections on the byte level if the upload has been terminated before a successful completion. A DIME package may include at least three record types: 1) Begin Message Record; 2) Image Records; and 3) End Message Record.

An exemplary construction of a Begin Message Record is shown in Table A below. In one embodiment, there is only one Begin Message Record per DIME package.

TABLE A

| | | | Record Header (12 Bytes or 96 Bits) | | |
|---|---|---|---|---|---|
| Message Type | Message Construction | Byte Value | Bits | Binary Value | Description Number |
| Begin Message Record | | OC | 3-7 | 00001 | Version Number of DIME Spec |
| | | | 2 | 1 | Message Begin Record |
| | | | 0-1 | 00 | |
| | | 10 | 4-7 | 0001 | Known type |
| | | | 0-3 | 000 | Must be zero |
| | Header | 0 | 0-7 | 00000000 | Not used |
| | | 0 | 0-7 | 00000000 | Not used |
| | | Value | 0-15 | value | Character Length of Book XML filename |
| | | 0 | 0-7 | 00000000 | Not used |
| | | 0 | 0-7 | 00000000 | Not used |
| | | Value | 0-31 | value | Number of bytes in XML file |
| | ID | variable size | | | Physical name of the Book XML filename |
| | ID Padding | variable size | | | Pad to 4 byte boundary |
| | Data | variable size | | | Actual content of XML File |
| | Data Padding | variable size | | | Pad to 4 byte boundary |

Actual content of the XML file may refer to the physical content of a specific book state information file 236 (which may be implemented using XML). An example of this content may be found in U.S. application Ser. No. ______ (Attorney Docket No. 09101.0002), which is herein expressly incorporated by reference.

An exemplary construction of an Image Record is shown in Table B below. In one embodiment, there is only one Image Record per image. If the DIME package is being created for an export operation, then for each photo in the book, there is a thumbnail image, a preview image, and a full resolution image. Each of these images may have corresponding Image Records in the DIME package. If the DIME package is being created for a purchase operation, then each photo in the book has one image with a corresponding Image Record in the DIME package. This one image may differ in resolution dependent on the size of a photo mold associated with the image.

TABLE B

| | | | Record Header (12 Bytes or 96 Bits) | | |
|---|---|---|---|---|---|
| Message Type | Message Construction | Byte Value | Bits | Binary Value | Description Number |
| Image Records | Header | 8 | 3-7 | 00001 | Version Number of DIME Spec |
| | | | 2 | 0 | |
| | | | 0-1 | 00 | |
| | | 10 | 4-7 | 0001 | Known type |
| | | | 0-3 | 000 | Must be zero |
| | | 0 | 0-7 | 00000000 | Not used |
| | | 0 | 0-7 | 00000000 | Not used |
| | | Value | 0-15 | value | Character Length of Image filename |
| | | 0 | 0-7 | 00000000 | Not used |
| | | 0 | 0-7 | 00000000 | Not used |
| | | Value | 0-31 | value | Number of bytes in Image file |
| | ID | variable size | | | Physical name of the Image filename |
| | ID Padding | variable size | | | Pad to 4 byte boundary |
| | Data | variable size | | | Actual content of Image File |
| | Data Padding | variable size | | | Pad to 4 byte boundary |

Actual content of the image file may refer to the binary data that represents the image file. An exemplary construction of an End Message Record is shown in Table C below. In one embodiment, there is only one End Message Record per DIME package.

TABLE C

| | | | Record Header (12 Bytes or 96 Bits) | | |
|---|---|---|---|---|---|
| Message Type | Message Construction | Byte Value | Bits | Binary Value | Description Number |
| End Message Record | Header | OC | 3-7 | 00001 | Version Number of DIME Spec |
| | | | 2 | 0 | |
| | | | 1 | 1 | Message End Record |
| | | | 0 | 0 | |
| | | 40 | 4-7 | 0100 | type is none |
| | | | 0-3 | 000 | Must be zero |
| | | 0 | 0-7 | 00000000 | Not used |
| | | 0 | 0-7 | 00000000 | Not used |
| | | 6 | 0-15 | 00000100 | Terminating ID Length for Partner |
| | | 0 | 0-7 | 00000000 | Not used |
| | | 0 | 0-7 | 00000000 | Not used |
| | | 0 | 0-31 | 0 | set to all zeros |
| | ID | variable size | | | Six character vendor ID (JASC01) |
| | ID Padding | variable size | | | Pad to 4 byte boundary |

Overall state information file 226 may be a file that is usable by bookmaker software 220 to keep track of certain global state information associated with bookmaker software 220. For example, overall state information file 226 may contain pointers to all of the digital photography books that have been created using bookmaker software 220 and flag the most recently opened book as the current document. Using these pointers and flag, upon opening, bookmaker software 220 may determine all of the books that a user should be able to edit, as well as designating the flagged book as the book currently being edited. The flag for the most recently opened book may include a unique identifier that identifies a specific book state information file 236 that corresponds to the flagged book. Bookmaker software 220 may then utilize the particular specific book state information file 236 to present the flagged book in the state in which it was left when bookmaker software 220 was closed.

Overall state information file 226 may also include book name information for each book, and information reflective of whether bookmaker software 220 is in particular modes, such as an autofit mode, advanced mode, or autobuild mode. Additionally, overall state information file 226 may include information on an upload state if the user is/was in the purchase workflow. Upload state information may include, for example, an upload page count and an indication of whether an upload is/was in progress. Further information on overall state information file 226 may be found in U.S. application Ser. No. ______ (Attorney Docket No. 09101.0002), which is herein expressly incorporated by reference.

Template file 228 may store all of the templates that may be used in a digital photography book designed using bookmaker software 220. New templates may be added to template file 228 in order to make it possible to use the new template in designing a book. Further information on template file 228 may be found in U.S. application Ser. No. ______ (Attorney Docket No. 09101.0002), which is herein expressly incorporated by reference.

User interface rendering file 230 and user interface element file 232 work in conjunction to create a user interface for bookmaker software 220. For example, user interface rendering file 230 may inform bookmaker software 220 how to render user interface element file 232, which includes the various user interface elements. In this manner, different user interfaces can easily be created by altering user interface rendering file 230 and/or user interface element file 232. For example, bookmaker software 220 may change the user interface dependent on whether a user is designing a coffee table book or a calendar.

FIG. 2B is a diagram of an exemplary partner client consistent with the principals of the present invention. A partner client, such as partner client 110a, may include CPU 240, input device 242, display 244, communications device 246, secondary storage 248, and memory 250. Memory 250 may include operating system 252, browser 254, digital book software 256, image files 258, and book files 260. The number of components in partner client 110a is not limited to what is shown and other variations in the number of arrangements of components are possible, consistent with embodiments of the invention. One of ordinary skill in the art will appreciate that the other partner clients depicted in FIG. 1 may be similar to partner client 110a.

CPU 240, input device 242, display 244, communications device 246, secondary storage 248, and memory 250 may be implemented using devices similar to those used for CPU 202, input device 204, display 206, communications device 208, secondary storage 210, and memory 212, as explained above with reference to FIG. 2A.

Memory 250 may include operating system 252, browser 254, digital book software 256, image files 258, and book files 260. Operating system 250 may be implemented using any suitable operating system, such as Windows 2000, Windows Me, Windows 98 Special Edition, Windows XP Home, or Windows XP professional, all manufactured by Microsoft Corporation. One of ordinary skill in the art will appreciate that other operating systems may also be used, including variations of the UNIX operating system such as LINUX, AIX™, and Solaris™. Browser 254 may be implemented using any suitable browser, such as Internet Explorer, Netscape, etc. In one embodiment, for example, Internet Explorer 5.0, 5.5, or 6.0 or higher may be used to implement browser 254. One of ordinary skill in the art will appreciate that other browsers may also be used.

Digital book software 256 is configured to assist users in designing digital photography books. For example, a user of partner client 110a may utilize digital book software 256 to import a number of digital pictures, organize those digital pictures, enhance the digital pictures in various ways, and build a digital photography book using the digital pictures. After a digital photography book has been created (e.g., designed) and purchased, the user may direct partner client 110a to upload information corresponding to the digital photography book to pre-printing servers 104 via network 108. Exemplary application programs that may be used to implement digital book software 256 may include, for example, PowerPoint manufactured by Microsoft Corporation, Adobe Photoshop manufactured by Adobe Systems Inc., and iPhoto manufactured by Apple Computer, Inc. One of ordinary skill in the art will appreciate that other applications that are operable to design digital photography books may alternatively be used as digital book software 256.

Image files 258 may correspond to digital pictures that a user has chosen to import for a digital photography book. Book files 260 may comprise files that correspond to digital photography books created by digital book software 256. Each book file 260 may include, for example, book information specifying the contents of a digital photography book. In one embodiment, book files 260 may have formats such as PowerPoint, PDF (Portable Document Format), or any other format that may be generated by digital book software 256.

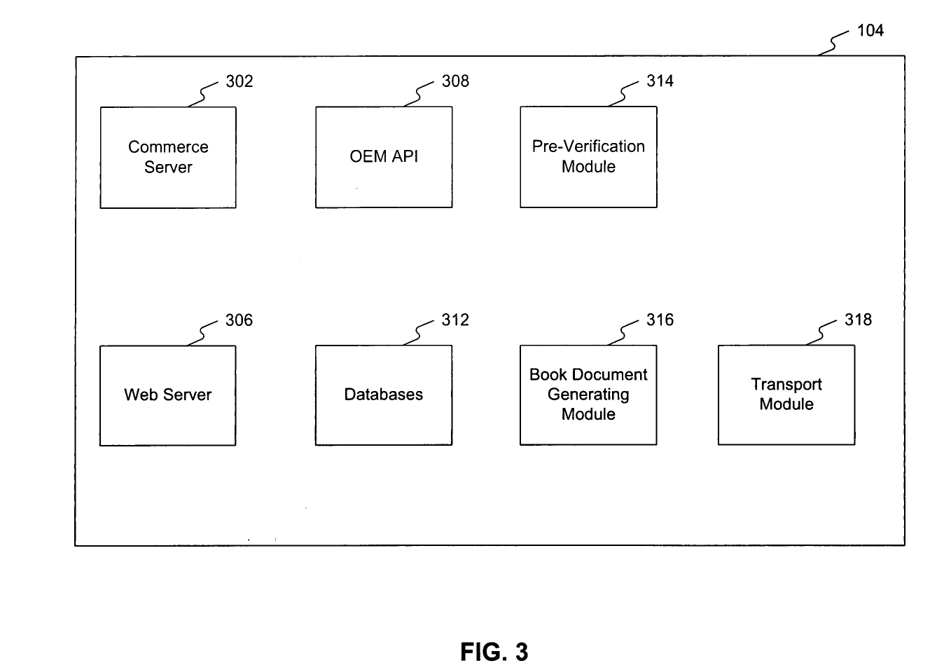

FIG. 3 is a diagram of exemplary pre-printing servers 104, consistent with the principals of the present invention. Pre-printing servers 104 may include commerce server 302, web server 306, OEM API 308, databases 312, pre-verification module 314, book document generating module 316, and transport module 318. The number of components in pre-printing servers 104 is not limited to what is shown and other variations in the number of arrangements of components are possible, consistent with embodiments of the invention.

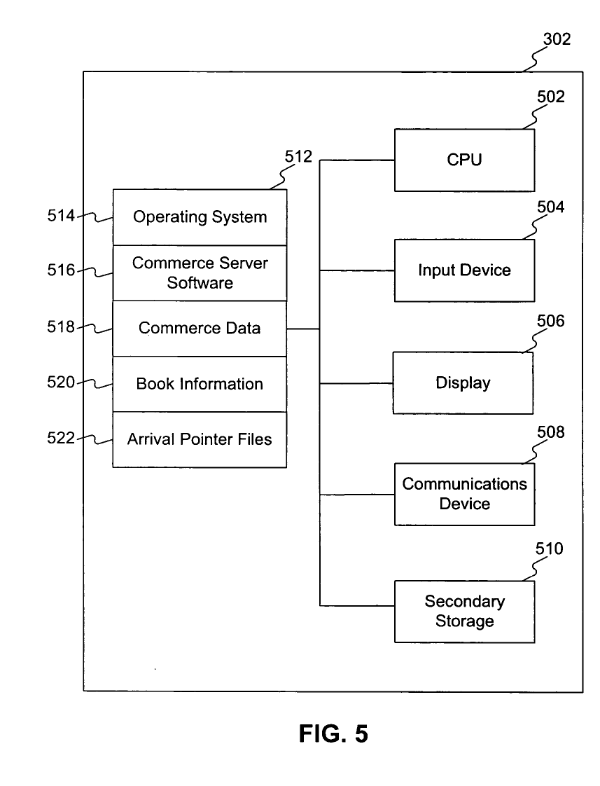

Commerce server 302 may be operable to communicate with a client 102 for the purpose of user registration, job submission, and payment. For example, when a user has finished designing a digital photography book and decides to purchase it, the user may select the appropriate option associated with bookmaker software 220. Thereafter, bookmaker software 220 may establish a connection with commerce server 302. The user may need to register with commerce server 302 in order to proceed. Registration may include, for example, providing commerce server 302 with a username and password, as well as other personal information. Once a user has registered, commerce server 302 may proceed to accept an order for a digital photography book from the user and request additional information such as payment information. After commerce server 302 has received all of the requisite information from the user, it may place an order for the book. Further information on commerce server 302 may be found below with reference to FIG. 5.

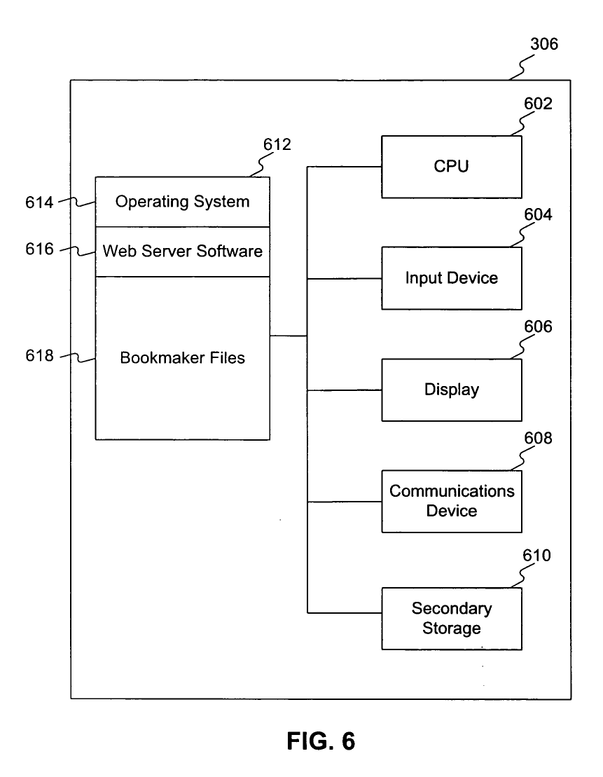

Web server 306 provides functionality for receiving traffic over a network from a client 102. For example, web server 304 may be a standard web server that a user may access at a client 102 using a web browser program, such as Internet Explorer or Netscape Communicator. In one embodiment, web server 306 may host a web site that a user may access in order to acquire software necessary to design a digital photography book, such as bookmaker software 220 and associated files (e.g., template file 228, user interface rendering file 230, and user interface element file 232). Further information on web server 306 may be found below with reference to FIG. 6.

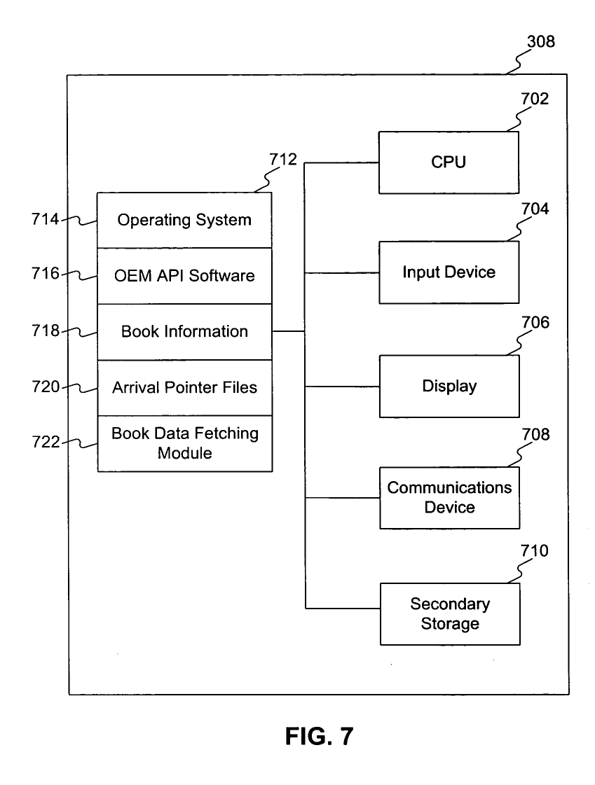

OEM API (Original Equipment Manufacturer Application Program Interface) 308 may be an interface for use by different vendors for communicating information related to an order for a digital photography book. For example, OEM API 308 may receive order information corresponding to a digital photography book from either commerce server 302 or directly from a client that does not use commerce server 302 to deal with digital photography book transactions (e.g., partner client 110). Additionally, in one embodiment, OEM API 308 may serve to submit a job for printing. For example, once an order for a digital photography book is ready OEM API 308 may receive an indication of such and proceed to generate an indication that a press-ready document is ready to be transported to a printing site 106. An order for a digital photography book may be considered ready, for example, when a press-ready document for the book has been generated. OEM API 308 may also store various information related to the order, such as customer information (e.g., name, credit card information, address, etc.), error information, order information (e.g., order quantity, shipping address, recipient information, size of book, binding style, cover color, number of pages, etc.), date, internal order reference number, partner's order reference number, etc. Further information on OEM API 308 may be found below with reference to FIG. 7.

Databases 312 may provide for storage of various assets related to digital photography books. Exemplary assets include, for example, customer information (e.g., name, credit card information, address, etc.), error information, order information (e.g., order quantity, shipping address, recipient information, size of book, binding style, cover color, number of pages, etc.), date, internal order reference number, partner's order reference number, etc. Assets may also include various book packages 224 and/or some book files 260.

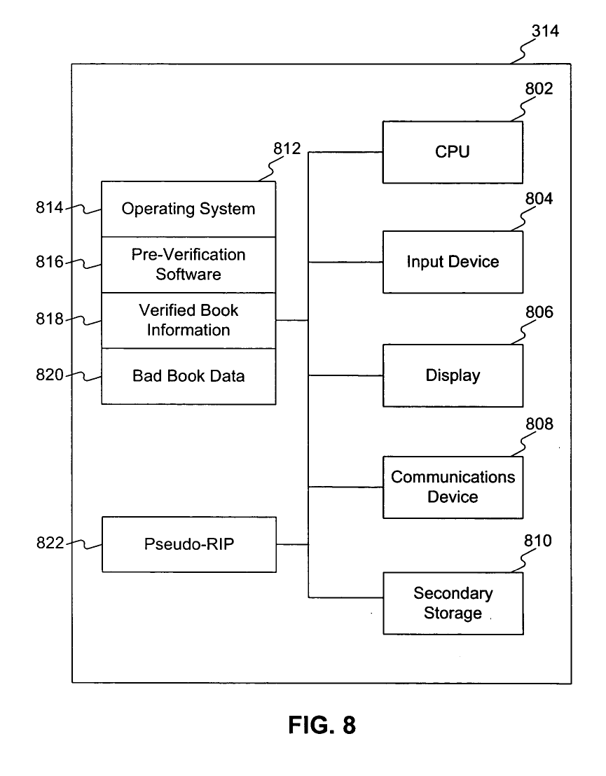

Pre-verification module 314 may be operable to receive information corresponding to digital photography books and check that information for errors. For example, pre-verification module 314 may receive a document for a book formatted in accordance with the PDF format or another predetermined format and send the formatted document to a pseudo-Raster Image Processor (RIP) for verification. Exemplary alternative file formats may include, among others, PostScript, Powerpoint, Quicktime, etc. The pseudo-RIP may also cause the document to be spooled but not printed to determine whether an error condition exists. Documents that cause an error condition may be set aside. Further information on pre-verification module 314 may be found below with reference to FIG. 8.

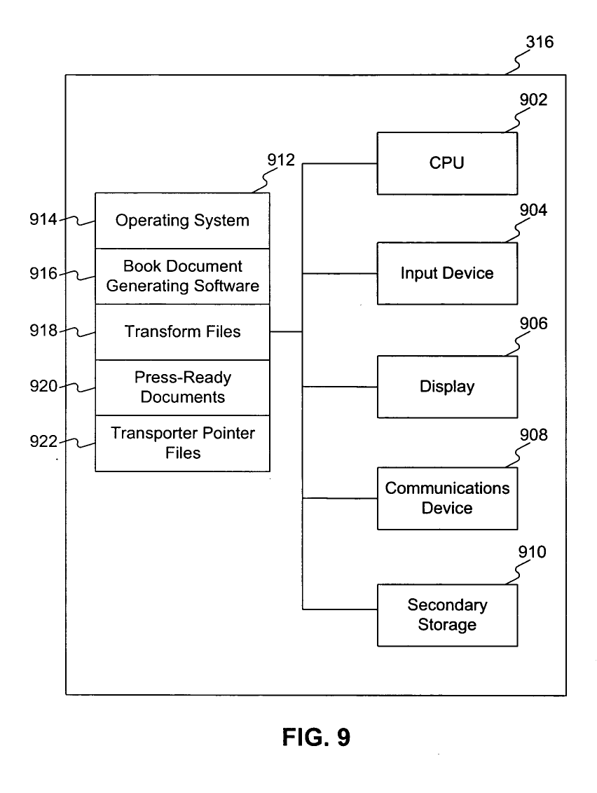

Book document generating module 316 may be operable to receive information corresponding to digital photography books and transform that information into a press-ready book document. For example, book document generating module 316 may receive information corresponding to a digital photography book that was designed at a bookmaker client 102 using bookmaker software 220, and transform that information into a press-ready document that is ready for printing at a printing site 106. Alternatively, book document generating module 316 may receive a document generated at a partner client 110 using digital book software 256 and transform that document into a press-ready document that is ready for printing at a printing site 106. Further information on book document generating module 316 may be found below with reference to FIG. 9.

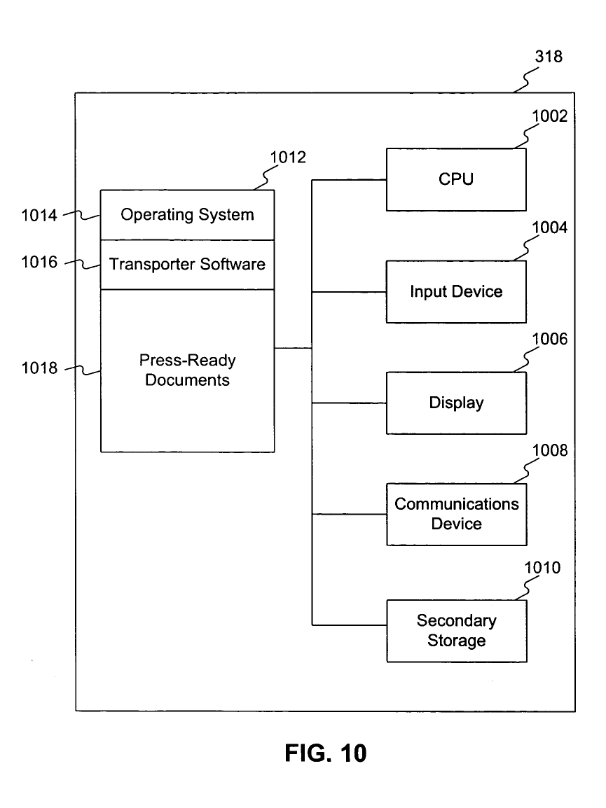

Transport module 318 may be operable to receive press-ready book documents and send those documents to an appropriate printing site 106. For example, transport module 318 may detect when a press-ready book document is ready to be sent to a printing site 106, and then use routing rules to decide which printing site 106 a particular press-ready book document is sent to. Further information on transport module 318 may be found below with reference to FIG. 10.

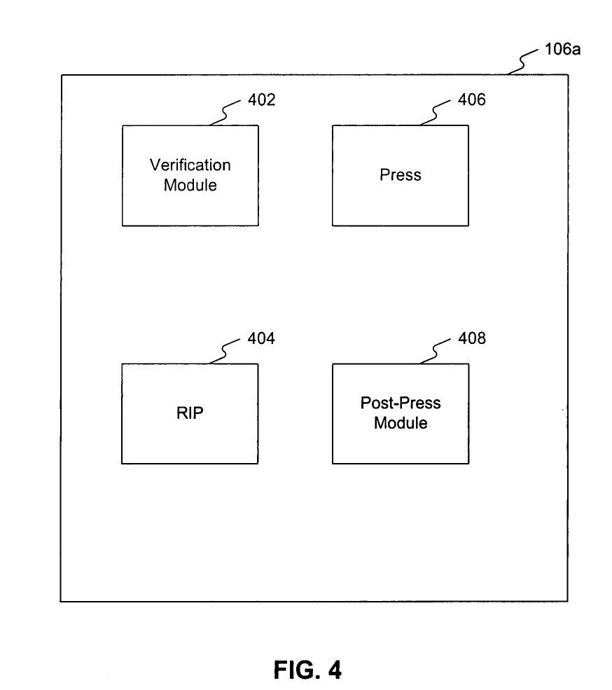

FIG. 4 is a diagram of an exemplary printing site, consistent with the principals of the present invention. A printing site, such as printing site 106a, may include verification module 402, Raster Image Processor (RIP) module 404, press 406, and post-press module 408. The number of components in printing site 106a is not limited to what is shown and other variations in the number of arrangements of components are possible, consistent with embodiments of the invention. One of ordinary skill in the art that the other printing sites depicted in FIG. 1 may be similar to printing site 106a.

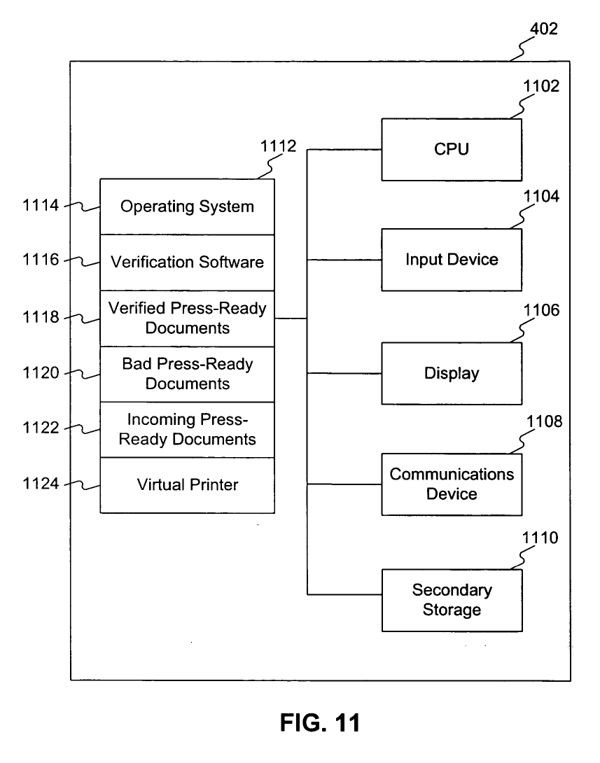

Verification module 402 may be operable to look for errors in received book documents. Errors include any condition that would cause a book document to be printed incorrectly. For example, verification module 402 may receive press-ready book documents from pre-printing servers 104. Verification module 402 may then proceed to determine whether the press-ready document causes an error condition. Documents that cause errors may be noted and moved aside. Further information on verification module 402 may be found below with reference to FIG. 11.

RIP module 404 may receive a verified book document from verification module 402 and convert the document into a series of bitmaps for each page, after determining that the document does not cause an error condition. Once RIP 404 has processed a book document, it may send the document to press 406, where the document is printed. Post-press module 408 may further process the printed document to produce a digital photography book. Such processing may include cutting, binding, trimming, etc. Thereafter, the digital photography book may be shipped to the proper user.

FIG. 5 is a diagram of an exemplary commerce server 302 consistent with the principals of the present invention. Commerce server 302 may include CPU 502, input device 504, display 506, communications device 508, secondary storage 510, and memory 512. Memory 512 may include operating system 514, commerce server software 516, commerce data 518, book information 520, and arrival pointer files 522. The number of components in commerce server 302 is not limited to what is shown and other variations in the number of arrangements of components are possible, consistent with embodiments of the invention.

CPU 502, input device 504, display 506, communications device 508, secondary storage 510, and memory 512 may be implemented using devices similar to those used for CPU 202, input device 204, display 206, communications device 208, secondary storage 210, and memory 212, as explained above with reference to FIG. 2A.

Memory 512 may include operating system 514, commerce server software 516, commerce data 518, book information 520, and arrival pointer files 522. Operating system 514 may be implemented may be implemented using any suitable server operating system, such as Windows 2000 Server manufactured by Microsoft Corporation. Commerce server software 516 may be operable to receive book information, such as book information 520, from a bookmaker client 102 or partner client 110. Exemplary book information 520 may comprise one or more final book packages 224 from a bookmaker client 102, or one or more book files 260 from a partner client 110.

Commerce server software 516 may also be operable to receive various commerce data 518 from a client 102 or 110. Such commerce data may include information related to specific orders for digital photography books. For example, commerce data 518 may include an identification of the type of order, the source of the order (e.g., identifies the partner or indicates that the order is from a bookmaker client), a partner's internal order number, shipping information (e.g., shipping name, address, and phone number), e-mail address, method of shipping information, type of currency, billing information (e.g., billing name, billing method, credit card type, credit card number, credit card expiration date, billing address), etc. One of ordinary skill in the art will appreciate that book information or commerce data received from a client 102 or 110 may be alternatively or additionally stored remotely from commerce server 302. For example, the information may be stored in databases 312 or another location.

In one embodiment, commerce server software 516 may communicate with a client 102 or 110 using a protocol such as Simple Object Access Protocol (SOAP) over an HTTP (Hypertext Transfer Protocol) or HTTPS (Hypertext Transfer Protocol, Secure) connection. Additionally, commerce server software 516 may be implemented using commercially available commerce software such as Microsoft Commerce Server 2002 available from Microsoft Corporation.

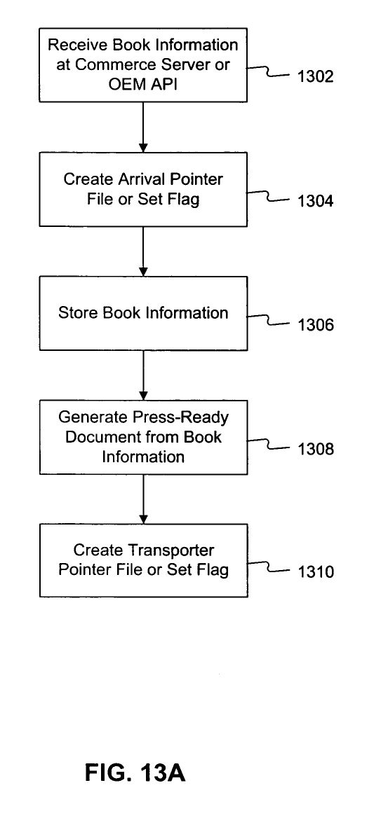

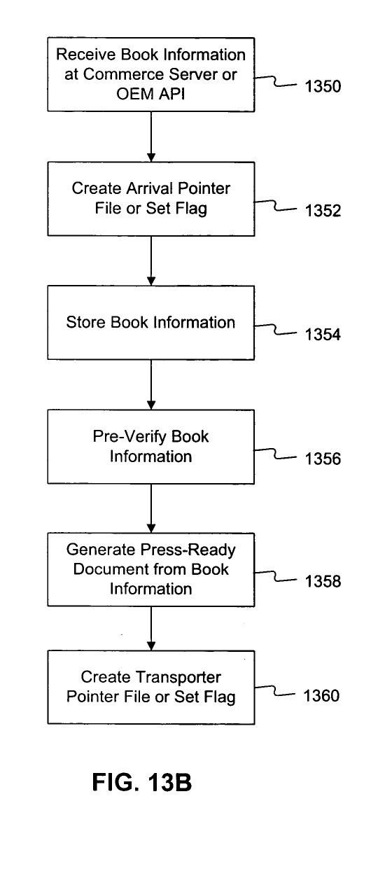

Upon receiving book information from a client, commerce server software 516 may also create a corresponding arrival pointer file 522 or set an arrival flag in a database. The arrival pointer file 522 or arrival flag may include information about the book information that it represents (e.g., specific final book package 224 or book file 260), and is generally indicative of the fact that the book information has arrived from a client 102 or 110. Arrival pointer files are described in more detail below with reference to FIG. 13A.

FIG. 6 is a diagram of an exemplary web server 306 consistent with the principals of the present invention. Web server 302 may include CPU 602, input device 604, display 606, communications device 608, secondary storage 610, and memory 612. Memory 612 may include operating system 614, web server software 616, and bookmaker files 618. The number of components in web server 306 is not limited to what is shown and other variations in the number of arrangements of components are possible, consistent with embodiments of the invention.

CPU 602, input device 604, display 606, communications device 608, secondary storage 610, and memory 612 may be implemented using devices similar to those used for CPU 202, input device 204, display 206, communications device 208, secondary storage 210, and memory 212, as explained above with reference to FIG. 2A.

Memory 612 may include operating system 614, web server software 616, and bookmaker files 618. Operating system 614 may be implemented may be implemented using any suitable server operating system, such as Windows 2000 Server manufactured by Microsoft Corporation. Web server software 616 may be generally operable to send out web pages in response to requests from remote browsers. More specifically, web server software may be operable to send a bookmaker client 102, in response to a download request from a bookmaker client 102, software that may be used to create a digital photography book. An example of such software is bookmaker files 618, which may include bookmaker software 220 and any additional files needed for bookmaker software 220.

FIG. 7 is a diagram of an exemplary OEM API 308 consistent with the principals of the present invention. OEM API 308 may include CPU 702, input device 704, display 706, communications device 708, secondary storage 710, and memory 712. Memory 712 may include operating system 714, OEM API software 716, book information 718, arrival pointer files 720, and book data fetching module 722. The number of components in OEM API 308 is not limited to what is shown and other variations in the number of arrangements of components are possible, consistent with embodiments of the invention.

CPU 702, input device 704, display 706, communications device 708, secondary storage 710, and memory 712 may be implemented using devices similar to those used for CPU 202, input device 204, display 206, communications device 208, secondary storage 210, and memory 212, as explained above with reference to FIG. 2A.

Memory 712 may include operating system 714, OEM API software 716, book information 718, arrival pointer files 720, and book data fetching module 722. Operating system 714 may be implemented may be implemented using any suitable server operating system, such as Windows 2000 Server manufactured by Microsoft Corporation. OEM API server software 716 may be operable to receive book information, such as book information 718, from a bookmaker client 102 or partner client 110. Exemplary book information 718 may comprise one or more final book packages 224 from a bookmaker client 102, or one or more book files 260 from a partner client 110.

Upon receiving book information from a client, OEM API software 716 may also create a corresponding arrival pointer file 720 or set an arrival flag in a database. The arrival pointer file 720 or arrival flag may include information about the book information that it represents (e.g., specific final book package 224 or book file 260), and is generally indicative of the fact that the book information has arrived from a client 102 or 110. Arrival pointer files are described in more detail below with reference to FIG. 13A.

Instead of first receiving book information from a partner client 110, OEM API software 716 may also be operable to first receive identification information from a partner client 110, and then based on that identification information, cause book data fetching module 722 to retrieve one or more book files 260 from the partner client 110. The identification information may include various data corresponding to one or more book files 260. Such data may include, for example, data reflective of an internal order number corresponding to a book file 260, data reflective of a partner's order number corresponding to a book file 260, data reflective of a location of a book file 260 on a partner client 110, data reflective of a file name of a book file 260, or any other data that may be helpful in uniquely identifying book files 260 associated with the identification information. An arrival pointer file 720 may then be created, or an arrival flag in a database may be set as described above.

Additionally, in one embodiment, OEM API software 716 may receive an indication that an order for a digital photography book is ready and proceed to generate an indication that a press-ready document is ready to be transported to a printing site 106. An order for a digital photography book may be considered ready, for example, when a press-ready document for the book has been generated

FIG. 8 is a diagram of an exemplary pre-verification module 314 consistent with the principals of the present invention. Pre-verification module 314 may include CPU 802, input device 804, display 806, communications device 808, secondary storage 810, memory 812, and pseudo-RIP 822. Memory 812 may include operating system 814, pre-verification software 816, verified book information 818, and bad book data 820. The number of components in pre-verification module 314 is not limited to what is shown and other variations in the number of arrangements of components are possible, consistent with embodiments of the invention.

CPU 802, input device 804, display 806, communications device 808, secondary storage 810, and memory 812 may be implemented using devices similar to those used for CPU 202, input device 204, display 206, communications device 208, secondary storage 210, and memory 212, as explained above with reference to FIG. 2A.

Memory 812 may include operating system 814, pre-verification software 816, verified book information 818, and bad book data 820. Operating system 814 may be implemented using any suitable server operating system, such as Windows 2000 Server manufactured by Microsoft Corporation. Pre-verification software 816 may help pre-verify book information. For example, pre-verification software 816 may be operable to retrieve book information and send the book information to a pseudo-RIP, such as pseudo-RIP 822, which spools the received book information. Pseudo-RIP 822 or pre-verification software 816 may then determine whether an error condition exists with the spooled book information. If such an error condition exists, then pseudo-RIP 822 or pre-verification software 816 may store the book information that caused the error condition as bad book data 820 or in another location. Pseudo-RIP 822 or pre-verification software 816 may store book information that does not cause an error condition as verified book information 818. An exemplary error may be that the book information has fonts or other formatting associated with it that are not currently supported by pre-printing servers 104 or printing sites 106. By pre-verifying the book information, pre-verification module 314 may help avoid a situation where a whole batch of documents is rejected when only one or a few documents in the batch causes errors.

FIG. 9 is a diagram of an exemplary book document generating module 316 consistent with the principals of the present invention. Book document generating module 316 may include CPU 902, input device 904, display 906, communications device 908, secondary storage 910, and memory 912. Memory 912 may include operating system 914, book document generating software 916, transform files 918, press-ready book documents 920, and transporter pointer files 922. The number of components in book document generating module 316 is not limited to what is shown and other variations in the number of arrangements of components are possible, consistent with embodiments of the invention.

CPU 902, input device 904, display 906, communications device 908, secondary storage 910, and memory 912 may be implemented using devices similar to those used for CPU 202, input device 204, display 206, communications device 208, secondary storage 210, and memory 212, as explained above with reference to FIG. 2A.

Memory 912 may include operating system 914, book document generating software 916, transform files 918, press-ready book documents 920, and transporter pointer files 922. Operating system 914 may be implemented may be implemented using any suitable server operating system, such as Windows 2000 Server manufactured by Microsoft Corporation. Book document generating software 916, for example, may be operable to detect and retrieve book information that is to be transformed into a press-ready document. Book document generating software 916 also may determine the source of the recently retrieved book information and generate a press-ready document 920 from the retrieved book information based on the source.

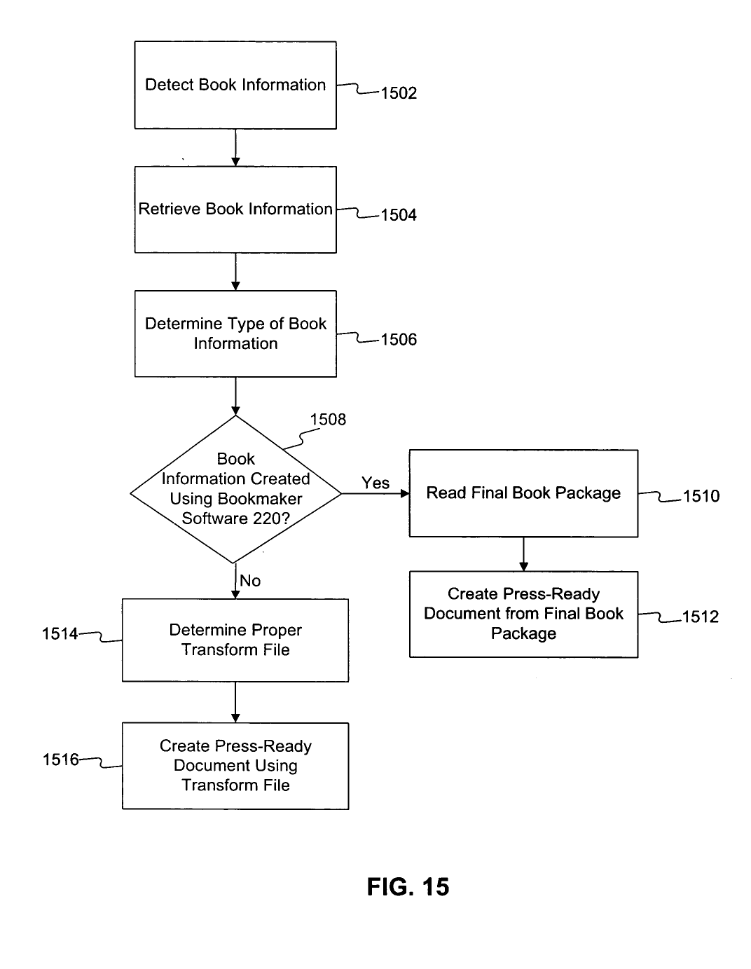

Transform files 918 may be used to help transform book information into a press-ready document. A transform file 920, for example, may include the following types of entries: unit; page media box width; page media box height; crop coordinates; crop box width and height; cover page crop coordinates; page gutter font; page gutter coordinates; color bar coordinates; print type (e.g., simplex or duplex); and/or other elements. Transform files are described in more detail below with reference to FIGS. 15-17.

Book document generating software 916 may also be operable to create a transporter pointer file 922 or set an appropriate transporter flag in a database, once a corresponding press-ready document 922 has been generated. Transporter pointer files are described in more detail below with reference to FIGS. 13A and 13B.

FIG. 10 is a diagram of an exemplary transporter module 318 consistent with the principals of the present invention. Transporter module 318 may include CPU 1002, input device 1004, display 1006, communications device 1008, secondary storage 1010, and memory 1012. Memory 1012 may include operating system 1014, transporter software 1016, and press-ready documents 1018. The number of components in transporter module 318 is not limited to what is shown and other variations in the number of arrangements of components are possible, consistent with embodiments of the invention.

CPU 1002, input device 1004, display 1006, communications device 1008, secondary storage 1010, and memory 1012 may be implemented using devices similar to those used for CPU 202, input device 204, display 206, communications device 208, secondary storage 210, and memory 212, as explained above with reference to FIG. 2A.

Memory 1012 may include operating system 1014, transporter software 1016, and press-ready documents 1018. Operating system 814 may be implemented may be implemented using any suitable server operating system, such as Windows 2000 Server manufactured by Microsoft Corporation. Transporter software 1016 may be operable to detect the presence of a transporter pointer file or set transporter flag, determine the location of a corresponding press-ready document, and then proceed to decide where to send the press-ready document (e.g., which printing site 106). Press-ready documents 1018 may be documents that were created by book document generating module 316 and are awaiting transport to an appropriate printing site 106). Alternatively or additionally, press-ready documents 1018 may be stored elsewhere on pre-printing servers 104, such as databases 312, pre-verification module 314, book document generating module 316, or OEM API 308.

FIG. 11 is a diagram of an exemplary verification module 402 consistent with the principals of the present invention. Verification module 402 may include CPU 1102, input device 1104, display 1106, communications device 1108, secondary storage 1110, and memory 1112. Memory 1112 may include operating system 1114, verification software 1116, verified press-ready book documents 1118, incoming press-ready book documents, and virtual printer 1124. The number of components in verification module 402 is not limited to what is shown and other variations in the number of arrangements of components are possible, consistent with embodiments of the invention.

CPU 1102, input device 1104, display 1106, communications device 1108, secondary storage 1110, and memory 1112 may be implemented using devices similar to those used for CPU 202, input device 204, display 206, communications device 208, secondary storage 210, and memory 212, as explained above with reference to FIG. 2A.

Memory 1112 may include operating system 1114, verification software 1116, verified press-ready book documents 1118, incoming press-ready book documents, and virtual printer 1124. Operating system 1114 may be implemented may be implemented using any suitable server operating system, such as Windows 2000 Server manufactured by Microsoft Corporation. Verification software 1116 may be operable to examine incoming press-ready documents 1122 (which are press-ready documents received from transporter module 318) to make an initial verification determination. For example, verification software 1116 may open an incoming press-ready document 1122 to determine whether the document is bad in any way. If a problem is found, then verification software 1116 may store the document as a bad press-ready document 1120. If no problem is found, then verification software 1116 may store the document as a verified press-ready document 1118 and send the verified press-ready document 1118 to RIP 404 for further verification and other processing.

Verification software 1116 may also monitor a bad document folder located on RIP 404. When verification software 1116 detects one or more bad press-ready documents in this folder, then verification software 1116 may send the bad press-ready document to virtual printer 1124 for processing. Virtual printer 1124 in turn may process the bad press-ready ready document from RIP 404 and thereafter send the document to press 406 for printing. The processing performed by virtual printer 1124, for example, may include creating a new press-ready document from the bad press-ready document. The new press-ready document may have a format consistent with the format currently acceptable to printing site 106.

### System Operation

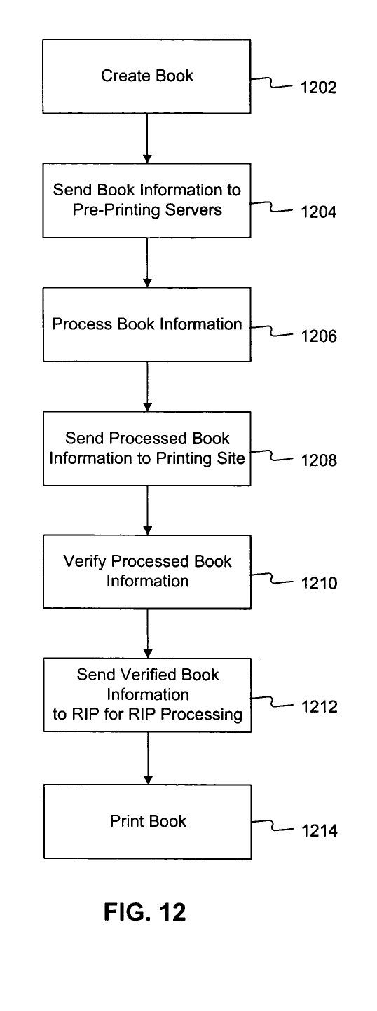

FIG. 12 is a diagram of a flowchart of a method for producing a digital photography book in a manner consistent with the present invention. Although the steps of the flowchart are described in a particular order, one skilled in the art will appreciate that these steps may be performed in a modified or different order. Further, one or more of the steps in FIG. 12 may be performed concurrently or in parallel.

First, a user of a client, such as bookmaker client 102a or partner client 110a, may create a digital photography book (step 1202). For example, a user may use software resident on bookmaker client 102a to import a number of digital pictures from one or more sources and thereafter design a digital photography book using at least some of those digital pictures. The aforementioned software, for example, may be downloaded from a web site. An example of such software is bookmaker software 220 and any additional files needed for bookmaker software 220. In one embodiment, the web site may be hosted by a server resident at pre-printing servers 104. Alternatively, the web site may be hosted elsewhere.

After accessing the web site, the user may choose to download the requisite software. Software may be downloaded, for example, for temporary storage in memory 212, so that after a user is finished using the software to create digital photography books, the software may be erased from memory 212, but information pertaining to the books may remain stored. Such information may include final book packages 224, overall state information file 226, and book folders 222, including image files 234 and specific book state information file 236. Alternatively, the downloaded software may remain stored after the user is finished using it.

Instead of accessing a web site and downloading the software, the user may alternatively buy the software at a retail store, receive the software as part of a package of software included with another product (e.g., a scanner, digital camera, etc.), or otherwise acquire the software.

Alternatively, a user may use software resident on a partner client 110 to import a number of digital pictures from one or more sources and thereafter design a digital photography book using at least some of those digital pictures. The aforementioned software, for example, may be downloaded from a web site, purchased by the user at a retail store, or otherwise acquired by the user. In one embodiment, the software may be software provided by a business entity that is business partners with the business entity responsible for operating pre-printing servers 104. The software may produce book information in a format other than the format used for final book packages 224. In this manner, a partner client 110 may utilize different software to create a digital photography book (e.g., software other than bookmaker software 220), but still be able to have pre-printing servers 104 and a printing site 106 work in conjunction to process and print the digital photography book.

The processing involved with creating a digital photography book using bookmaker software 220 is described in more detail in U.S. application Ser. No. ______ (Attorney Docket No. 09101.0002), which is herein expressly incorporated by reference.

After the user has designed/created the digital photography book, client 102 or 110 may send information corresponding to the digital photography book to pre-printing servers 104 (step 1204). For example, client 102a may send one or more final book packages 224, which may be implemented using a DIME package, to pre-printing servers 104. Alternatively, a client 110 may send one or more book files 260 to pre-printing servers 104. Book files 260 may have formats such as PowerPoint, PDF, or any other format that may be generated by digital book software 256 resident on client 110.

Thereafter, pre-printing servers 104 may process the book information (step 1206). For example, pre-printing servers 104 may extract certain information from a final book package 224 or book file 260 and transform the extracted information into a press-ready format. The processing of book information is described in more detail below with reference to FIGS. 13A and 13B.

Pre-printing servers 104 may then send the processed book information to an appropriate printing site 106 (step 1208). For example, pre-printing servers 104 may select a printing site 106, such as printing site 106a, based on a number of factors, such as availability of press, time of day, shift capability, location of press, weather, availability of delivery services, or other factors, and then send a press-ready document to printing site 106a. More particularly, transporter module 318 may determine that at least one press-ready document is ready for transport to a printing site 106. Such a determination may occur, for example, when transporter module 318 detects the presence of a transporter pointer file or set transporter flag. A transporter pointer file or set transporter flag serves as an indication that a press-ready document is ready for transport, as well as providing the location of that press-ready document. Transporter module 318 may then select a suitable printing site 106 using one or more of the factors noted above.

Next, printing site 106a may further process the book information as necessary. For example, verification module 402 may be utilized to verify the processed book information (step 1210). More particularly, verification module 402 may receive press-ready book documents from pre-printing servers 104 and examine the documents to make an initial verification determination. For example, verification software 1116 may open an incoming press-ready document 1122 to determine whether the document is bad in any way. This determination may be made by using a program such as Adobe Acrobat to open the document, and attempting to navigate around the document (e.g., move from page to page). One of ordinary skill in the art will appreciate that programs other than Adobe Acrobat may be used to open the document. If a problem is found, then verification software 1116 may store the document as a bad press-ready document 1120. When a file is stored as a bad press-ready document, verification software 1116 may send an indication to or otherwise alert a system administrator of the error. The system administrator or other personnel may then deal with the error in a suitable way.

If no problem is found by verification software 1116, then verification software 1116 may store the document as a verified press-ready document 1118 and send the verified press-ready document 1118 to RIP module 404 for further verification and other processing (step 1212). In one embodiment, verification software 1116 may specifically send the verified press-ready document to a folder (known as a hot folder) on RIP module 404. RIP module 404 monitors its hot folder so that when it receives a verified press-ready document, RIP module 404 may proceed to start rendering the document for printing (e.g., convert the document into a series of bitmaps for each page). However, if RIP module 404 cannot properly render the verified press-ready document, then RIP module 404 may reject the document and place it in a bad document folder resident on RIP module 404. Exemplary reasons for RIP module 404 rejecting the document may include the document being created with a software version incompatible with RIP module 404, the document being created with a software type incompatible with RIP module 404, etc.

In the meantime, verification software 1116 may monitor the bad document folder located on RIP module 404. When verification software 1116 detects one or more bad press-ready documents in this folder, then verification software 1116 may retrieve and send the bad press-ready document to virtual printer 1124 for processing. Virtual printer 1124 in turn may process the bad press-ready document from RIP module 404 and thereafter send the document back to RIP module 404, which may attempt to render the document again. The processing performed by virtual printer 1124, for example, may include creating a new press-ready document from the bad press-ready document. The new press-ready document may have a format consistent with the format currently acceptable to printing site 106. Once RIP module 404 has properly rendered a verified press-ready document, it may send the document to press 406 for printing (step 1214).

FIG. 13A is a diagram of a flowchart of a method for processing book information received from a client in a manner consistent with the present invention. Although the steps of the flowchart are described in a particular order, one skilled in the art will appreciate that these steps may be performed in a modified or different order. Further, one or more of the steps in FIG. 13A may be performed concurrently or in parallel. The steps of FIG. 13A may correspond to step 1206 from FIG. 12.

Commerce server 302 or OEM API 308 may first receive book information from a client 102 or 110 (step 1302). For example, commerce software 516 or OEM API software 716 may receive one or more final book packages 224 from a client 102, or one or more book files 260 from a client 110. In an alternative embodiment, receiving book information may comprise OEM API software 716 receiving identification information from a partner client 110, and then based on that identification information, book data fetching module 722 retrieving one or more book files 260 from the partner client 110. The identification information may include various data corresponding to one or more book files 260. Such data may include, for example, data reflective of an internal order number corresponding to a book file 260, data reflective of a partner's order number corresponding to a book file 260, data reflective of a location of a book file 260 on a partner client 110, data reflective of a file name of a book file 260, or any other data that may be helpful in uniquely identifying book files 260 associated with the identification information.

Commerce server 302 or OEM API 308 may also create an arrival pointer file or set an arrival flag in a database (step 1304). The arrival pointer file or arrival flag may include information about the specific final book package 224 or book file 260 that it represents. An exemplary arrival pointer file is shown in Table D below.

TABLE D

InputFile=\\server\in_directory\pdf_incoming.pdf
OutputFile=\\server\out_directory\pdf_transformed.pdf
Type=0 or 1 or 2 {0=book, 1=album, 2=calendar}
Firstname=Sam
Lastname=Edge
Address=100
Street=Main Street
City=Danville
State=CA
Zip=94506
Country=US
FOID=12345
PartnerID=APPLE01
PartnerCommerceRefernceCode=1234
TransactionDate=1/17/03 6:13:20
Quantity=10
PageCount=15
PrintType=duplex (or simplex)
TemplateID=Apple.Book.1185
PrintXML=Apple.11x8.5-duplex.xml

This exemplary arrival pointer file corresponds to a book file 260 created by a partner client 110. One of ordinary skill in the art will appreciated that similar arrival pointer files can be created for final book packages 224. FOID refers to the internal order reference number. PartnerCommerceReferenceCode refers to the partner's internal order number. PrintXML refers to an XML file that contains the coordinates and details for transforming the partner book file 260 into a press-ready document. InputFile refers to a name of the incoming book file 260. OutputFile refers to a name to be assigned to the book file 260 after it has been transformed into a press-ready document. TemplateID refers to the format associated with the incoming book file 260. The arrival pointer file, for example, may be stored locally (e.g., as an arrival pointer file 524 or 720) and/or in databases 312. One of ordinary skill in the art will appreciate that an arrival flag may include similar information as an arrival pointer file, and may be stored in databases 312.

Commerce server 302 or OEM API 308 also stores the received book information (step 1306). For example, a final book package 224 or a book file 260 that corresponds to the created arrival pointer file or arrival flag may be stored locally and/or in databases 312. Locally stored book information, for example, may be stored as incoming book data 522 or incoming book data 718.

Thereafter, book document generating module 316 may generate a press-ready document from the received book information (step 1308). For example, book document generating module 316 may be monitoring specific folders resident on commerce server 302, OEM API 308, and/or databases 312. Most of the folders may represent a specific partner and correspond to digital photography books not created using bookmaker software 220. Another such folder may correspond to digital photography books that have been created using bookmaker software 220. It is in these aforementioned folders, for example, that arrival pointer files are stored. When book document generating module 316 detects that an arrival pointer file has been created, it reads the arrival pointer file and then accesses the book information corresponding to the arrival pointer file.

In a similar manner, book document generating module may instead monitor databases 312 for a set arrival flag, and upon detecting one, access the book information corresponding to the arrival flag. After accessing the book information, book document generating module 316 may proceed to generate and store the afore-mentioned press-ready document. Generation of a press-ready document is described in more detail below with reference to FIG. 15.

Once book document generating module 316 has generated the press-ready document, book document generating module 316 may also create a transporter pointer file or set an appropriate transporter flag in a database (step 1310). The transporter pointer file or transporter flag, for example, may include various information corresponding to the press-ready document. Such information may include data reflective of a storage location of the press-ready document, internal order reference number, partner order reference number, various customer order information, or any other useful information.

The transporter pointer file, for example, may be stored locally on book document generating module 316 (e.g., as a transporter pointer file 922) and/or in databases 312. More particularly, the transporter pointer file may be stored in a transporter pointer file directory, which may be monitored by transporter module 318. When transporter module 318 detects the presence of a transporter pointer file, it may read the file to determine the location of the corresponding press-ready document, and then proceed to decide where to send the press-ready document in accordance with step 1208 in FIG. 12 above. One of ordinary skill in the art will appreciate that a transporter flag may include similar information as a transporter pointer file, and may be stored in databases 312. One of ordinary skill in the art will also appreciate that in the case of transporter flags, transporter module 318 may monitor databases 312 for an appropriate set transporter flag, instead of monitoring the afore-mentioned transporter pointer file directory.

In an alternative environment, instead of creating the transporter pointer file or setting the transporter flag itself, book document generating module 316 may create an order pointer file or set an order flag. An order pointer file or order flag may indicate that the press-ready document is ready for continued processing, as well as provide a location where the press-ready document may be found. OEM API 308 may be monitoring the order flag or for the presence of a new order pointer file. When OEM API 308 detects that the order flag has been set or that a new order pointer file has been created, OEM API 308 may proceed to create a transporter pointer file or set a transporter flag. Transporter module 318 may thereafter detect the transporter pointer file or transporter flag and perform its normal processing as described above.

FIG. 13B is a diagram of a flowchart of a method for processing book information received from a client, where the processing includes pre-verifying book information, in a manner consistent with the present invention. Although the steps of the flowchart are described in a particular order, one skilled in the art will appreciate that these steps may be performed in a modified or different order. Further, one or more of the steps in FIG. 13B may be performed concurrently or in parallel. The steps of FIG. 13B may correspond to step 1206 from FIG. 12.

Steps 1350, 1352, and 1354 may be performed by commerce server 302 or OEM API 308 in a manner similar to that described above in steps 1302, 1304, and 1306, respectively, in FIG. 13A. In FIG. 13B, however, once an arrival pointer file has been created or an arrival flag set, and the corresponding book information has been stored, pre-verification module 314 may proceed to pre-verify the book information before book document generating module 316 creates a press-ready document (step 1356). For example, pre-verification module 314 may be monitoring specific folders resident on commerce server 302, OEM API 308, and/or databases 312. Most of the folders may represent a specific partner and correspond to digital photography books created using software other than bookmaker software 220. Another such folder may correspond to digital photography books that have been created using bookmaker software 220. It is in these aforementioned folders, for example, that arrival pointer files are stored. When pre-verification module 314 detects that an arrival pointer file has been created, it reads the arrival pointer file and then accesses the book information corresponding to the arrival pointer file.

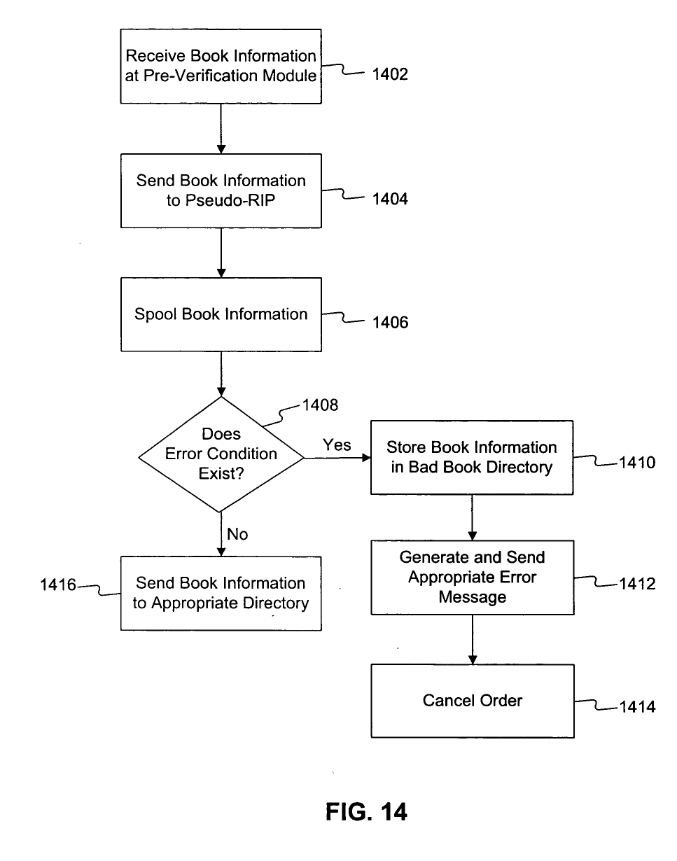

In a similar manner, pre-verification module 314 may instead monitor databases 312 for a set arrival flag, and upon detecting one, access the book information corresponding to the arrival flag. After accessing the book information, pre-verification module 314 may attempt to pre-verify the book information. Pre-verification of book information is described in more detail below with reference to FIG. 14.

Thereafter, book document generating module 316 may generate a press-ready document from verified book information (step 1358). For example, book document generating module 316 may be monitoring specific folders resident on pre-verification module 314 and/or databases 312. These folders may store verified book information dependent on the type of book information. For example, folders may store verified book information in different folders dependent on the page sizes associated with the book information. When book document generating module 316 detects that verified book information is present in at least one of the monitored folders, it retrieves the verified book information and processes the information in a manner appropriate for the folder in which the information was found. Generation of a press-ready document is described in more detail below with reference to FIG. 15. Step 1360 may be performed in a manner similar to that described above with reference to step 1310 from FIG. 13A.

FIG. 14 is a diagram of a flowchart of a method for pre-verifying book information in a manner consistent with the present invention. Although the steps of the flowchart are described in a particular order, one skilled in the art will appreciate that these steps may be performed in a modified or different order. Further, one or more of the steps in FIG. 14 may be performed concurrently or in parallel. The steps of FIG. 14 may correspond to step 1356 from FIG. 13B.

First, pre-verification module 314 may receive book information (step 1402). For example, as described above with reference to FIG. 13B, pre-verification module 314 may monitor specific folders resident on commerce server 302, OEM API 308, and/or databases 312. When pre-verification module 314 detects that an arrival pointer file has been created and stored in one of these folders, it reads the arrival pointer file and then retrieves the book information corresponding to the arrival pointer file. In a similar manner, pre-verification module 314 may instead monitor databases 312 for a set arrival flag, and upon detecting one, retrieve the book information corresponding to the arrival flag.

After receiving the book information, pre-verification module 314 may send the book information to a pseudo-RIP, such as pseudo-RIP 822 (step 1404). Pseudo-RIP 822 may proceed to spool the received book information (step 1406). In other words, pseudo-RIP 822 stores the received book information in a queue, where it waits to be printed. Pseudo-RIP 822 or pre-verification software 816 may then determine whether an error condition exists with the spooled book information (step 1408).

An error condition may exist if the book information did not spool properly for some reason. If such an error condition exists, then pre-verification module 314 may store the book information that caused the error condition in a bad book directory (step 1410). A bad book directory such as this may be stored as bad book data 820 on pre-verification module 314 or on databases 312. Pre-verification module also generates and sends an appropriate error message (step 1412). This error message, for example, may inform a system administrator or other user that printing may not occur because the book information (e.g., a final book package 224 or book file 260) is invalid in some way. The order for a digital photography book corresponding to the book information is thereafter canceled (step 1414).

If no error condition exists, then pre-verification module 314 may instead store the book information as verified book information and place the verified book information in an appropriate directory (step 1416). For example, pre-verification module 314 may store verified book information in a different folder dependent on the type of book information. In one embodiment, pre-verification module 314 may store verified book information in different folders dependent on the page sizes associated with the book information. The afore-mentioned folders may be stored, for example, as verified book data 818 on pre-verification module 314 or on databases 312.

FIG. 15 is a diagram of a flowchart of a method for generating a press-ready document in a manner consistent with the present invention. Although the steps of the flowchart are described in a particular order, one skilled in the art will appreciate that these steps may be performed in a modified or different order. Further, one or more of the steps in FIG. 15 may be performed concurrently or in parallel. The steps of FIG. 15 may correspond to step 1308 from FIG. 13A or step 1358 from FIG. 13B.

First, book document generating module 316 detects book information that is to be transformed into a press-ready document (step 1502). For example, as explained above with reference to FIG. 13A, in the case that processing of book information does not include pre-verification, book document generating module 316 may monitor specific folders resident on commerce server 302, OEM API 308, and/or databases 312. Most of the folders may represent a specific partner and correspond to digital photography books not created using bookmaker software 220. Another such folder may correspond to digital photography books that have been created using bookmaker software 220. It is in these aforementioned folders, for example, that arrival pointer files, such as arrival pointer files 524 or 720, are stored. When book document generating module 316 detects that an arrival pointer file has been created, it reads the arrival pointer file and then retrieves the book information (step 1504) corresponding to the arrival pointer file.

In a similar manner, book document generating module may instead monitor databases 312 for a set arrival flag, and upon detecting one, retrieve the book information corresponding to the arrival flag (step 1504).

When processing of book information includes pre-verification, book document generating module 316 may be monitoring specific folders resident on pre-verification module 314 and/or databases 312. These folders may store verified book information dependent on the type of book information. For example, folders may store verified book information in different folders dependent on the page sizes associated with the book information. When book document generating module 316 detects that verified book information is present in at least one of the monitored folders, it retrieves the verified book information (step 1504).

Book document generating module 316 also may determine the source of the recently retrieved book information (step 1506). This determination may be made, for example, based on the particular location (e.g., folder) in which the book information was found. Alternatively, the book information itself, a corresponding arrival pointer file, or arrival database flag may include an indication of the source. Source refers to the type of software that was used to create the digital photography book that corresponds to the book information (e.g., bookmaker software 220, digital book software 256, etc.).

If the retrieved book information was not created using bookmaker software 220 (step 1508—No), then the book information is not a final book package 224. In this situation, book document generating module 316 needs to determine an appropriate transform file (step 1514). A transform file may be a file that provides detailed information to book document generating module 316 for the transformation of the book information into a press-ready document. A transform file for example may include the following types of entries: unit; page media box width; page media box height; crop coordinates; crop box width and height; cover page crop coordinates; page gutter font; page gutter coordinates; color bar coordinates; print type (e.g., simplex or duplex); and/or other elements.

There are several ways in which book document generating module 316 can determine the proper transform file to use. For example, the arrival pointer file or arrival flag may include the filename and location of a transform file. This is the case, for example, with the exemplary arrival pointer file depicted in Table D above. In that arrival pointer file, PrintXML refers to a transform file that contains the coordinates and details for transforming book information into a press-ready document.

Another way to determine the proper transform file may be to choose a particular transform file based on the location from which book document generating module 316 retrieves the book information. For example, the transform file could be selected dependent on which folder the book information is found, where different folders correspond to different sources of book information. Alternatively, the transform file could be selected dependent on the formatting associated with the book information. For example, a different transform file may be used when the book information corresponds to an 11×8.5 inch document from that used when the book information corresponds to an 8.5×6.38 inch document. One of ordinary skill in the art will appreciate that other ways of identifying a transform file may be utilized.

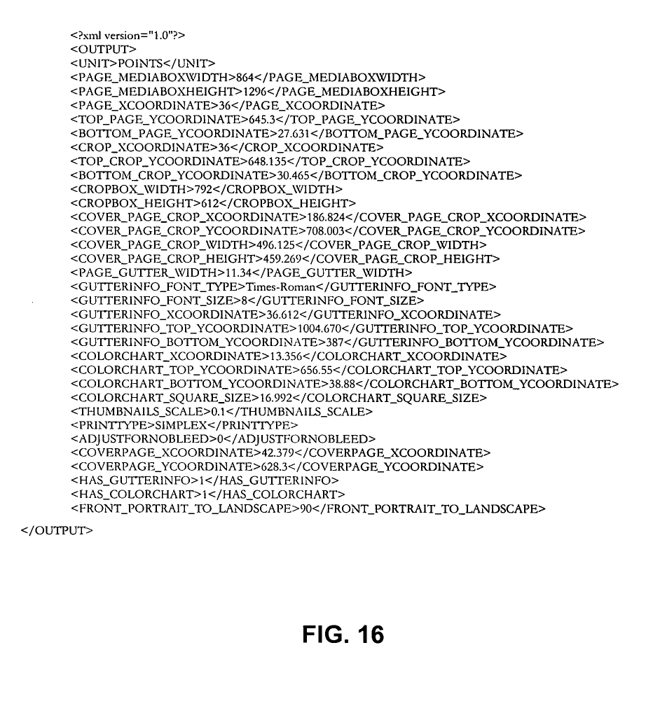

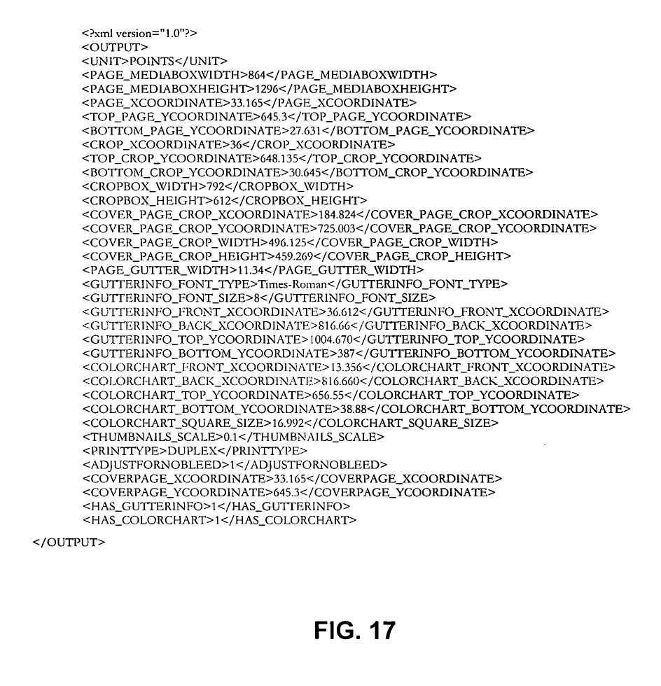

In one embodiment, a transform file may be implemented in XML. An exemplary transform file implemented in XML is shown in FIG. 16. The transform file depicted in FIG. 16 is representative of a file that may be used to transform a simplex (e.g., single-sided printing) 11.08×8.58-inch document into a press-ready 12×18-inch document. In this example, the coordinate system has (0, 0) as being located at the bottom left corner of the 12×18-inch page, with “X” representing a horizontal measurement and “Y” representing a vertical measurement. FIG. 17 shows another exemplary transform file implemented in XML. The transform file depicted in FIG. 17, however, is representative of a file that may be used to transform a duplex (e.g., two-sided printing) 11.08×8.58-inch document into a press-ready 12×18-inch document.

In FIG. 16, UNIT describes the measurement system being used. In one embodiment, the most commonly used measurement system is points—1/72^{nd} of an inch. PAGE_MEDIABOXWIDTH refers to the width of the 12×18-inch page in points. PAGE_MEDIABOXHEIGHT refers to the height of the 12×18-inch page in points. PAGE_XCOORDINATE refers to the starting ‘X’ coordinate for the bottom page. TOP_PAGE_YCOORDINATE refers to the ‘Y’ coordinate for the top most page. BOTTOM_PAGE_YCOORDINATE refers to the ‘Y’ coordinate for the bottom most page. CROP_XCOORDINATE refers to the crop mark ‘X’ coordinate for the bottom page. TOP_CROP_YCOORDINATE refers to the crop mark ‘Y’ coordinate for the top page. BOTTOM_CROP_YCOORDINATE refers to the crop mark ‘Y’ coordinate for the bottom page. CROPBOX_WIDTH refers to the width of the crop box for both top and bottom pages. CROPBOX_HEIGHT refers to the height of the crop box for both top and bottom pages.

COVER_PAGE_CROP_XCOORDINATE refers to the cover page ‘X’ crop mark coordinate. COVER_PAGE_CROP_YCOORDINATE refers to the cover page ‘Y’ crop mark coordinate. COVER_PAGE_CROP_WIDTH refers to the cover page crop mark width. COVER_PAGE_CROP_HEIGHT refers to the cover page crop mark height. COVERPAGE_XCOORDINATE refers to the ‘X’ coordinate for the cover page. COVERPAGE_YCOORDINATE refers to the ‘Y’ coordinate for the cover page. PAGE_GUTTER_WIDTH refers to the width of the page gutter in points. GUTTERINFO_FONT_TYPE refers to the font used for text in the page gutter. GUTTERINFO_FONT_SIZE refers to the font size for the text in the page gutter. GUTTERINFO_XCOORDINATE refers to the ‘X’ coordinate for the page gutter. GUTTERINFO_TOP_YCOORDINATE refers to the ‘Y’ coordinate for the top page gutter. GUTTERINFO_BOTTOM_YCOORDINATE refers to the ‘Y’ coordinate for the bottom page gutter. COLORCHART_XCOORDINATE refers to the ‘X’ coordinate for the color bar. COLORCHART_TOP_YCOORDINATE refers to the ‘Y’ coordinate for the top page color bar. COLORCHART_BOTTOM_YCOORDINATE refers to the ‘Y’ coordinate for the bottom page color bar. COLORCHART_SQUARE_SIZE refers to the point size of the square for each color in the color bar. THUMBNAILS_SCALE refers to the scale in tenths for generated page thumbnails. PRINTTYPE refers to the print type: simplex or duplex. ADJUSTFORNOBLEED can adjust a page if no page bleed is desired. HAS_GUTTERINFO is a toggle for turning on (1) or off (0) the gutter info. HAS_COLORCHART is toggle for turning on (1) or off (0) the color bar. FRONT_PORTRAIT_TO_LANDSCAPE may be used to rotate pages measured in degrees.

The elements of the transform file in FIG. 17 are very similar to those of FIG. 16, except for a few differences as noted below.

More particularly, in FIG. 17, GUTTERINFO_FRONT_XCOORDINATE and GUTTERINFO_BACK_XCOORDINATE replace GUTTERINFO_XCOORDINATE from FIG. 16. Additionally, COLORCHART_FRONT_XCOORDINATE and COLORCHART_BACK_XCOORDINATE replace COLORCHART_XCOORDINATE from FIG. 16.

Transform files may include other elements not explicitly shown in FIGS. 16 and 17. Some examples are elements relating to bar codes. Exemplary elements that may be used to place bar codes on a press-ready document may include BARCODE_XCOORDINATE, BARCODE_TOP_YCOORDINATE, or, BARCODE_BOTTOM_YCOORDINATE.

Once the proper transform file has been identified, book document generating module 316 may proceed to create a press-ready document using the transform file (step 1516). The press-ready document may include elements such as color bars, bar codes, crop marks, customer order information, and other information. In one embodiment, customer order information may include partner ID (if the order is from a partner), order number, page number, and number of pages. The customer order information, for example, may be placed in a gutter area on each page so that the information remains on the pages after being cut but will be hidden from view within the spine of the book. Similarly, color bars and bar codes may be placed on each page in such a manner as to make them hidden within the spine of the book after the book has been completed.

In one embodiment, the last page of a press-ready document may include thumbnail images of each page in the digital photography book. This page of thumbnail images may be used by a system administrator or another user to help detect errors. The transform file, for example, may include an element determining whether the page of thumbnail images is created.

By creating a press-ready document, book document generating module 316 eliminates the need of a partner client to generate a press-ready document. This is important for at least two reasons: 1) removes the responsibility from the partner of having to constantly maintain code to create press-ready documents in the format specified by printing site 106a; 2) makes it possible for pre-printing servers 104 to append objects such as color bars, bar codes, and customer order information to the press-ready document.

In one embodiment, when the book information being transformed into a press-ready document is a PDF file, the creation of the press-ready document may be accomplished by using the transform file in conjunction with a software tool such as PDFLib library from PDFLib GmbH. More particularly, PDF Import, which is a companion product to PDFLib, contains a parser for the PDF file format that prepares pages from an existing PDF document for placing this page into a new press-ready PDF. This library also provides functions for translating, scaling, and rotating pages. At no time is the imported PDF page modified. Rather, PDF Import treats the page as a single object and does not at any time attempt to deconstruct the partner's PDF document (e.g., the book information) into individual objects. In other words, the PDF document is read as a template and imported directly into another PDF document as is. This strategy insures that the book document generating module 316 never modifies the incoming page, thus insuring that the content page in the press-ready PDF is identical to the incoming partner page.

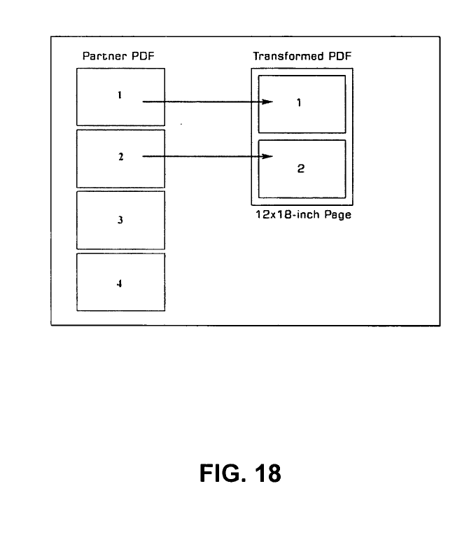

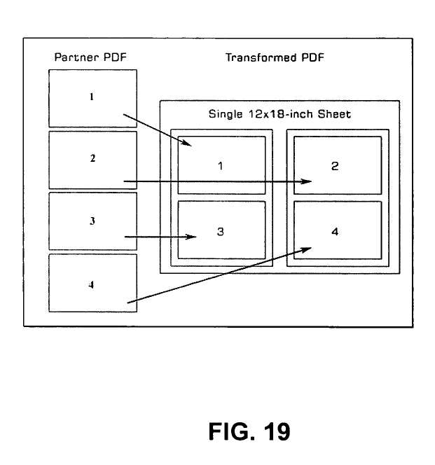

In order to properly impose the partner PDF document into the press-ready PDF document, book document generating module 316 may read the transform file, which provides the variable data necessary to perform the transform correctly. The transform file informs book document generating module 316 exactly how to place the partner PDF in the press-ready PDF document. FIG. 18 shows an exemplary page imposition for a simplex layout. FIG. 19 shows an exemplary page imposition for a duplex layout. The examples of FIGS. 18 and 19 assume landscape page layouts and 11×8.5-inch partner pages.

After the partner PDF document is imported, it is then mapped into the press-ready format. This logical mapping, for example, may require a page to be rotated by 90 degrees if the partner layout is portrait and sized in the 11×8.5-inch form. The page may be rotated in its entirety so the service does not have to read object by object.

Because the page is treated as a single object for transformation, or imposition, into the 12×18-inch press-ready PDF, the time to transform the PDF is very fast. Transformation time is dependent on the size of the PDF content and not the number of pages. A representation of the time required to transform a PDF is shown in Table E below. It should be noted that this representation is for the transformation itself and does not include moving files across network shares.

TABLE E

| Transform Time | | Number of Pages | PDF Size |
|---|---|---|---|
| .5 | seconds | 15 | 2.4 MB |
| <1 | second | 15 | 7.5 MB |
| 3 | seconds | 36 | 104 MB |

An additional feature of book document generating module 316 is the ability to scale the page size, if necessary. This feature may be important, for example, if a partner would like to use the same PDF to generate two or more final print sizes for the same content. It should be noted that the PDF in physical size (MB) does not change. However, the convenience of being able to scale the pages directly on a server and thus avoiding the necessity to upload two PDF files is enormous.

If the retrieved book information was created using bookmaker software 220 (step 1508—Yes), then the book information is a final book package 224. As described above with reference to FIG. 2A, a final book package 224 includes at least the contents of a specific book state information file 236 and corresponding image files. Accordingly, book document generating module 316 reads the specific book state information file 236 that corresponds to the final book package 224 being processed (step 1510). The specific book state information file 236 includes the various layout rules, text strings for captions, headers, footers, pointers to image files to used for each page, etc., as described above with reference to FIG. 2A. Further information on specific book state information file 236 may be found in U.S. application Ser. No. ______ (Attorney Docket No. 09101.0002), which is herein expressly incorporated by reference.

Book document generating module 316 may then use the information from the specific state information file 236 to create a press-ready document (step 1512). In one embodiment, a press-ready document may comprise a PDF document where the page size of each page is 12×18 inches. The press-ready document may include elements such as color bars, bar codes, crop marks, customer order information, and other information, as previously described. In order to create a press-ready document from a specific state information file 236, book document generating module 316 may, for example, first use the information from the specific state information file 236 to generate an 11×8.5 inch PDF document. One of ordinary skill in the art will appreciate that sizes other than 11×8.5 inch or document types other than PDF may be used. Book document generating module 316 may then use a suitable transform file to transform the 11×8.5 inch PDF document into a press-ready document. A suitable transform file in this case may be one that helps transform an 11×8.5 inch PDF document into a 12×18 inch PDF document.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

1. A method for producing a digital photography book, comprising:
receiving book information corresponding to a digital photography book;
selecting a transform file for use in transforming the book information into a press-ready document, the press-ready document corresponding to the digital photography book and including at least two of crop marks, barcode information and customer order information; and
creating the press-ready document from the book information using the selected transform file.

2. The method of claim 1, wherein the book information is treated as a single object during the creating.

3. The method of claim 1, the receiving comprising:
detecting the presence of a file indicating the arrival of the book information, the file including information reflecting the storage location of the book information; and
retrieving the book information from the storage location.

4. The method of claim 1, the receiving comprising:
detecting that an arrival flag has been set, the arrival flag corresponding to the book information and indicating the arrival of the book information; and
retrieving the book information.

5. The method of claim 3, wherein the file is an arrival pointer file.

6. The method of claim 5, wherein the arrival pointer file comprises an indication of the transform file.

7. The method of claim 5, wherein the arrival pointer file comprises at least one of an internal order number, a partner order number, and a template identification.

8. The method of claim 3, the selecting comprising:
choosing the transform file based on information from the arrival pointer file.

9. The method of claim 1, the selecting comprising:
choosing the transform file based on a location where the book information was received.

10. The method of claim 1, the selecting comprising:
choosing the transform file based on a format associated with the book information.

11. The method of claim 1, wherein the transform file includes information specifying a size of the press-ready document.

12. The method of claim 1, wherein the transform file includes information specifying locations of crop marks.

13. The method of claim 1, wherein the transform file includes information specifying crop box size.

14. The method of claim 1, wherein the transform file includes information specifying locations of color bars.

15. The method of claim 1, wherein the transform file includes information specifying locations of page gutters.

16. The method of claim 1, wherein the transform file includes information specifying locations of barcodes.

17. The method of claim 1, wherein the transform file includes information specifying print type.

18. The method of claim 17, wherein the print type is simplex.

19. The method of claim 17, wherein the print type is duplex.

20. The method of claim 1, wherein the transform file is implemented in XML.

21. The method of claim 1, wherein the press-ready document further includes color bar information.

22. The method of claim 1, wherein the customer order information is located in a gutter area of each page in the press-ready document.

23. The method of claim 21, wherein the barcode information and color bar information are located on each page so that they are hidden within a spine of the digital photography book after the book has been completed.

24. The method of claim 1, the creating comprising:
reading the transform file; and
importing the book information into the press-ready document based on information from the transform file.

25. The method of claim 1, further comprising:
printing the press-ready document.

26. The method of claim 1, further comprising:
providing an indication that the press-ready document is ready.

27. The method of claim 26, the providing comprising:
creating a transporter pointer file indicating that the press-ready document is ready to be transported to a printing site.

28. The method of claim 26, the providing comprising:
setting a transporter flag indicating that the press-ready document is ready to be transported to a printing site.

29. The method of claim 26, the providing comprising:
creating an order pointer file indicating that the press-ready document is ready for further processing.

30. The method of claim 26, the providing comprising:
setting an order flag indicating that the press-ready document is ready for further processing.

31. The method of claim 27, further comprising:
detecting the presence of the transporter pointer file, the transporter pointer file including information reflecting the storage location of the press-ready document;
retrieving the press-ready document from the storage location; and
forwarding the press-ready document to a printing site.

32. The method of claim 31, the forwarding comprising:
selecting one of a plurality of printing sites; and
sending the press-ready document to the selected printing site.

33. The method of claim 32, wherein the selected printing site is chosen based on at least one of availability of press, time of day, shift capability, location of press, weather, and availability of delivery services.

34. The method of claim 31, further comprising:
verifying the press-ready document; and
printing the press-ready document based on a determination that the press-ready document passed verification.

35. The method of claim 34, the verifying comprising:
performing an error check on the press-ready document;
processing the press-ready document for printing based on a determination that the press-ready document passed the error check; and
creating a new document from the press-ready document based on a determination that the press-ready document was not properly processed.

36. The method of claim 35, the verifying further comprising:
based on a determination that the press-ready document failed the error check, designating the press-ready document as a bad press-ready document.

37. A method for producing a digital photography book, comprising:
receiving book information corresponding to a digital photography book;
selecting a transform file for use in transforming the book information into a press-ready document;
creating the press-ready document from the book information using the selected transform file;
verifying the press-ready document; and
printing the press-ready document based on a determination that the press-ready document passed verification.

38. The method of claim 37, wherein the book information is treated as a single object.

39. The method of claim 37, the receiving comprising:
detecting the presence of a file indicating the arrival of the book information, the file including information reflecting the storage location of the book information; and
retrieving the book information from the storage location.

40. The method of claim 37, the receiving comprising:
detecting that an arrival flag has been set, the arrival flag corresponding to the book information and indicating the arrival of the book information; and
retrieving the book information.

41. The method of claim 37, the selecting comprising:
choosing the transform file based on a location where the book information was received.

42. The method of claim 37, the selecting comprising:
choosing the transform file based on a format associated with the book information.

43. The method of claim 37, the creating comprising:
reading the transform file; and
importing the book information into the press-ready document based on information from the transform file.

44. The method of claim 37, the verifying comprising:
performing an error check on the press-ready document;
processing the press-ready document for printing based on a determination that the press-ready document passed the error check; and
creating a new document from the press-ready document based on a determination that the press-ready document was not properly processed.

45. The method of claim 44, the verifying further comprising:
based on a determination that the press-ready document failed the error check, designating the press-ready document as a bad press-ready document.

46. A method for producing a digital photography book, comprising:
receiving book information corresponding to a digital photography book;
pre-verifying the book information;
determining a type of the book information if the book information passed pre-verification; and
creating a press-ready document from the book information based on the determination.

47. The method of claim 46, the receiving comprising:
detecting the presence of a file indicating the arrival of the book information, the file including information reflecting the storage location of the book information; and
retrieving the book information from the storage location.

48. The method of claim 46, the receiving comprising:
detecting that an arrival flag has been set, the arrival flag corresponding to the book information and indicating the arrival of the book information; and
retrieving the book information.

49. The method of claim 46, the pre-verifying comprising:
spooling the book information;
determining whether the spooled book information has an error; and
storing the spooled book information as verified book information based on a determination that no error exists.

50. The method of claim 49, the pre-verifying further comprising:
when an error exists, storing the spooled book information as bad book information, and canceling an order for the digital photography book.

51. The method of claim 46, the determining comprising:
detecting verified book information in one of a plurality of folders; and
ascertaining the type of the book information based on in which folder the verified book information is located, wherein verified book information is stored in different folders dependent on page sizes associated with the verified book information.

52. The method of claim 46, the creating comprising:
selecting a transform file for use in transforming the book information into the press-ready document, the transform file being selected based on the type of the book information; and
constructing the press-ready document from the book information using the selected transform file.

53. The method of claim 52, the constructing comprising:
reading the transform file; and
importing the book information into the press-ready document based on information from the transform file.

54. The method of claim 46, further comprising:
providing an indication that the press-ready document is ready.

55. The method of claim 54, the providing comprising:
creating a transporter pointer file indicating that the press-ready document is ready to be transported to a printing site.

56. The method of claim 54, the providing comprising:
setting a transporter flag indicating that the press-ready document is ready to be transported to a printing site.

57. The method of claim 54, the providing comprising:
creating an order pointer file indicating that the press-ready document is ready for further processing.

58. The method of claim 54, the providing comprising:
setting an order flag indicating that the press-ready document is ready for further processing.

59. The method of claim 55, further comprising:
detecting the presence of the transporter pointer file, the transporter pointer file including information reflecting the storage location of the press-ready document;
retrieving the press-ready document from the storage location; and
forwarding the press-ready document to a printing site.

60. The method of claim 59, the forwarding comprising:
selecting one of a plurality of printing sites; and
sending the press-ready document to the selected printing site.

61. The method of claim 60, wherein the selected printing site is chosen based on at least one of availability of press, time of day, shift capability, location of press, weather, and availability of delivery services.

62. The method of claim 59, further comprising:
verifying the press-ready document; and
printing the press-ready document based on a determination that the press-ready document passed verification.

63. The method of claim 62, the verifying comprising:
performing an error check on the press-ready document;
processing the press-ready document for printing based on a determination that the press-ready document passed the error check;
creating a new document from the press-ready document based on a determination that the press-ready document was not properly processed.

64. The method of claim 63, the verifying further comprising:
based on a determination that the press-ready document failed the error check, designating the press-ready document as a bad press-ready document.

65. A method for producing a digital photography book, comprising:
receiving book information corresponding to a digital photography book;
determining a source of the book information;
extracting state information pertaining to the digital photography book from the book information based on the determination;
creating a book document from the book information using the extracted state information; and
creating a press-ready document from the book document using a transform file, wherein the transform file is used in transforming book documents into press-ready documents.

66. The method of claim 65, wherein the transform file includes information specifying locations of crop marks.

67. The method of claim 65, wherein the transform file includes information specifying crop box size.

68. The method of claim 65, wherein the transform file includes information specifying locations of color bars.

69. The method of claim 65, wherein the transform file includes information specifying locations of page gutters.

70. The method of claim 65, wherein the transform file includes information specifying locations of barcodes.

71. The method of claim 65, wherein the transform file includes information specifying print type.

72. The method of claim 71, wherein the print type is simplex.

73. The method of claim 71, wherein the print type is duplex.

74. The method of claim 65, wherein the transform file is implemented in a document markup language.

75. The method of claim 65, wherein the document marking language is extensible and supports user-defined fields.

76. The method of claim 65, wherein the press-ready document includes at least one of crop marks, barcode information, customer order information, and color bar information.

77. The method of claim 65, wherein the customer order information is located in a gutter area of each page in the press-ready document.

78. The method of claim 76, wherein the barcode information and color bar information are located on each page so that they are hidden within a spine of the digital photography book after the book has been completed.

79. The method of claim 65, the creating comprising:
reading the transform file; and
importing the book document into the press-ready document based on information from the transform file.

80. The method of claim 65, further comprising:
printing the press-ready document.

81. A method for producing a digital photography book, comprising:
receiving book information corresponding to a digital photography book;
transforming the book information into a first press-ready document;
performing an error check on the first press-ready document;
processing the first press-ready document for printing based on a determination that the first press-ready document passed the error check;
creating a new press-ready document from the first press-ready document based on a determination that the first press-ready document was not properly processed; and
printing the new press-ready document.

82. An apparatus for producing a digital photography book, comprising:
means for receiving book information corresponding to a digital photography book;
means for selecting a transform file for use in transforming the book information into a press-ready document, the press-ready document corresponding to the digital photography book and including at least two of crop marks, barcode information and customer order information; and
means for creating the press-ready document from the book information using the selected transform file.

83. The apparatus of claim 82, wherein the book information is treated as a single object during the creating.

84. The apparatus of claim 82, the means for receiving comprising:
means for detecting the presence of a file indicating the arrival of the book information, the file including information reflecting the storage location of the book information; and
means for retrieving the book information from the storage location.

85. The apparatus of claim 82, the means for receiving comprising:
means for detecting that an arrival flag has been set, the arrival flag corresponding to the book information and indicating the arrival of the book information; and
means for retrieving the book information.

86. The apparatus of claim 84, wherein the file is an arrival pointer file.

87. The apparatus of claim 86, wherein the arrival pointer file comprises an indication of the transform file.

88. The apparatus of claim 86, wherein the arrival pointer file comprises at least one of an internal order number, a partner order number, and a template identification.

89. The apparatus of claim 84, the means for selecting comprising:
means for choosing the transform file based on information from the arrival pointer file.

90. The apparatus of claim 82, the means for selecting comprising:
means for choosing the transform file based on a location where the book information was received.

91. The apparatus of claim 82, the means for selecting comprising:
means for choosing the transform file based on a format associated with the book information.

92. The apparatus of claim 82, wherein the transform file includes information specifying a size of the press-ready document.

93. The apparatus of claim 82, wherein the transform file includes information specifying locations of crop marks.

94. The apparatus of claim 82, wherein the transform file includes information specifying crop box size.

95. The apparatus of claim 82, wherein the transform file includes information specifying locations of color bars.

96. The apparatus of claim 82, wherein the transform file includes information specifying locations of page gutters.

97. The apparatus of claim 82, wherein the transform file includes information specifying locations of barcodes.

98. The apparatus of claim 82, wherein the transform file includes information specifying print type.

99. The apparatus of claim 98, wherein the print type is simplex.

100. The apparatus of claim 98, wherein the print type is duplex.

101. The apparatus of claim 82, wherein the transform file is implemented in XML.

102. The apparatus of claim 82, wherein the press-ready document further includes color bar information.

103. The apparatus of claim 82, wherein the customer order information is located in a gutter area of each page in the press-ready document.

104. The apparatus of claim 102, wherein the barcode information and color bar information are located on each page so that they are hidden within a spine of the digital photography book after the book has been completed.

105. The apparatus of claim 82, the means for creating comprising:
means for reading the transform file; and
means for importing the book information into the press-ready document based on information from the transform file.

106. The apparatus of claim 82, further comprising:
means for printing the press-ready document.

107. The apparatus of claim 82, further comprising:
means for providing an indication that the press-ready document is ready.

108. The apparatus of claim 107, the means for providing comprising:
means for creating a transporter pointer file indicating that the press-ready document is ready to be transported to a printing site.

109. The apparatus of claim 107, the means for providing comprising:
means for setting a transporter flag indicating that the press-ready document is ready to be transported to a printing site.

110. The apparatus of claim 107, the means for providing comprising:
means for creating an order pointer file indicating that the press-ready document is ready for further processing.

111. The apparatus of claim 107, the means for providing comprising:
means for setting an order flag indicating that the press-ready document is ready for further processing.

112. The apparatus of claim 108, further comprising:
means for detecting the presence of the transporter pointer file, the transporter pointer file including information reflecting the storage location of the press-ready document;
means for retrieving the press-ready document from the storage location; and
means for forwarding the press-ready document to a printing site.

113. The apparatus of claim 112, the means for forwarding comprising:
means for selecting one of a plurality of printing sites; and
means for sending the press-ready document to the selected printing site.

114. The apparatus of claim 113, wherein the selected printing site is chosen based on at least one of availability of press, time of day, shift capability, location of press, weather, and availability of delivery services.

115. The apparatus of claim 112, further comprising:
means for verifying the press-ready document; and
means for printing the press-ready document based on a determination that the press-ready document passed verification.

116. The apparatus of claim 115, the means for verifying comprising:
means for performing an error check on the press-ready document;
means for processing the press-ready document for printing based on a determination that the press-ready document passed the error check;
means for creating a new document from the press-ready document based on a determination that the press-ready document was not properly processed.

117. The apparatus of claim 116, the means for verifying further comprising:
means for designating, based on a determination that the press-ready document failed the error check, the press-ready document as a bad press-ready document.

118. An apparatus for producing a digital photography book, comprising:
means for receiving book information corresponding to a digital photography book;
means for selecting a transform file for use in transforming the book information into a press-ready document;
means for creating the press-ready document from the book information using the selected transform file;
means for verifying the press-ready document; and
means for printing the press-ready document based on a determination that the press-ready document passed verification.

119. The apparatus of claim 118, wherein the book information is treated as a single object.

120. The apparatus of claim 118, the means for receiving comprising:
means for detecting the presence of a file indicating the arrival of the book information, the file including information reflecting the storage location of the book information; and
means for retrieving the book information from the storage location.

121. The apparatus of claim 118, the means for receiving comprising:
means for detecting that an arrival flag has been set, the arrival flag corresponding to the book information and indicating the arrival of the book information; and
means for retrieving the book information.

122. The apparatus of claim 118, the means for selecting comprising:
means for choosing the transform file based on a location where the book information was received.

123. The apparatus of claim 118, the means for selecting comprising:
means for choosing the transform file based on a format associated with the book information.

124. The apparatus of claim 118, the means for creating comprising:
means for reading the transform file; and
means for importing the book information into the press-ready document based on information from the transform file.

125. The apparatus of claim 118, the means for verifying comprising:
means for performing an error check on the press-ready document;
means for processing the press-ready document for printing based on a determination that the press-ready document passed the error check; and
means for creating a new document from the press-ready document based on a determination that the press-ready document was not properly processed.

126. The apparatus of claim 125, the means for verifying further comprising:
means for designating, based on a determination that the press-ready document failed the error check, the press-ready document as a bad press-ready document.

127. An apparatus for producing a digital photography book, comprising:
means for receiving book information corresponding to a digital photography book;
means for pre-verifying the book information;
means for determining a type of the book information if the book information passed pre-verification; and
means for creating a press-ready document from the book information based on the determination.

128. The apparatus of claim 127, the means for receiving comprising:
means for detecting the presence of a file indicating the arrival of the book information, the file including information reflecting the storage location of the book information; and
means for retrieving the book information from the storage location.

129. The apparatus of claim 127, the means for receiving comprising:
means for detecting that an arrival flag has been set, the arrival flag corresponding to the book information and indicating the arrival of the book information; and
means for retrieving the book information.

130. The apparatus of claim 127, the means for pre-verifying comprising:
means for spooling the book information;
means for determining whether the spooled book information has an error; and
means for storing the spooled book information as verified book information based on a determination that no error exists.

131. The apparatus of claim 130, the means for pre-verifying further comprising:
means for storing, when an error exists, the spooled book information as bad book information, and canceling an order for the digital photography book.

132. The apparatus of claim 127, the means for determining comprising:
means for detecting verified book information in one of a plurality of folders; and
means for ascertaining the type of the book information based on in which folder the verified book information is located, wherein verified book information is stored in different folders dependent on page sizes associated with the verified book information.

133. The apparatus of claim 127, the means for creating comprising:
means for selecting a transform file for use in transforming the book information into the press-ready document, the transform file being selected based on the type of the book information; and
means for constructing the press-ready document from the book information using the selected transform file.

134. The apparatus of claim 133, the means for constructing comprising:
means for reading the transform file; and
means for importing the book information into the press-ready document based on information from the transform file.

135. The apparatus of claim 127, further comprising:
means for providing an indication that the press-ready document is ready.

136. The apparatus of claim 135, the means for providing comprising:
means for creating a transporter pointer file indicating that the press-ready document is ready to be transported to a printing site.

137. The apparatus of claim 135, the means for providing comprising:
means for setting a transporter flag indicating that the press-ready document is ready to be transported to a printing site.

138. The apparatus of claim 135, the means for providing comprising:
means for creating an order pointer file indicating that the press-ready document is ready for further processing.

139. The apparatus of claim 135, the means for providing comprising:
means for setting an order flag indicating that the press-ready document is ready for further processing.

140. The apparatus of claim 136, further comprising:
means for detecting the presence of the transporter pointer file, the transporter pointer file including information reflecting the storage location of the press-ready document;
means for retrieving the press-ready document from the storage location; and
means for forwarding the press-ready document to a printing site.

141. The apparatus of claim 140, the means for forwarding comprising:
means for selecting one of a plurality of printing sites; and
means for sending the press-ready document to the selected printing site.

142. The apparatus of claim 141, wherein the selected printing site is chosen based on at least one of availability of press, time of day, shift capability, location of press, weather, and availability of delivery services.

143. The apparatus of claim 140, further comprising:
means for verifying the press-ready document; and
means for printing the press-ready document based on a determination that the press-ready document passed verification.

144. The apparatus of claim 143, the means for verifying comprising:
means for performing an error check on the press-ready document;
means for processing the press-ready document for printing based on a determination that the press-ready document passed the error check; and
means for creating a new document from the press-ready document based on a determination that the press-ready document was not properly processed.

145. The apparatus of claim 144, the means for verifying further comprising:
means for designating, based on a determination that the press-ready document failed the error check, the press-ready document as a bad press-ready document.

146. An apparatus for producing a digital photography book, comprising:
means for receiving book information corresponding to a digital photography book;
means for determining a source of the book information;
means for extracting state information pertaining to the digital photography book from the book information based on the determination;
means for creating a book document from the book information using the extracted state information; and
means for creating a press-ready document from the book document using a transform file, wherein the transform file is used in transforming book documents into press-ready documents.

147. The apparatus of claim 146, wherein the transform file includes information specifying locations of crop marks.

148. The apparatus of claim 146, wherein the transform file includes information specifying crop box size.

149. The apparatus of claim 146, wherein the transform file includes information specifying locations of color bars.

150. The apparatus of claim 146, wherein the transform file includes information specifying locations of page gutters.

151. The apparatus of claim 146, wherein the transform file includes information specifying locations of barcodes.

152. The apparatus of claim 146, wherein the transform file includes information specifying print type.

153. The apparatus of claim 152, wherein the print type is simplex.

154. The apparatus of claim 152, wherein the print type is duplex.

155. The apparatus of claim 146, wherein the transform file is implemented in a document markup language.

156. The apparatus of claim 146, wherein the document marking language is extensible and supports user-defined fields.

157. The apparatus of claim 146, wherein the press-ready document includes at least one of crop marks, barcode information, customer order information, and color bar information.

158. The apparatus of claim 146, wherein the customer order information is located in a gutter area of each page in the press-ready document.

159. The apparatus of claim 157, wherein the barcode information and color bar information are located on each page so that they are hidden within a spine of the digital photography book after the book has been completed.

160. The apparatus of claim 146, the means for creating comprising:
means for reading the transform file; and
means for importing the book document into the press-ready document based on information from the transform file.

161. The apparatus of claim 146, further comprising:
means for printing the press-ready document.

162. An apparatus for producing a digital photography book, comprising:
means for receiving book information corresponding to a digital photography book;
means for transforming the book information into a first press-ready document;
means for performing an error check on the first press-ready document;
means for processing the first press-ready document for printing based on a determination that the first press-ready document passed the error check;
means for creating a new press-ready document from the first press-ready document based on a determination that the first press-ready document was not properly processed; and
means for printing the new press-ready document.

163. A computer-readable medium containing instructions for performing a method for producing a digital photography book, the method comprising:
receiving book information corresponding to a digital photography book;
selecting a transform file for use in transforming the book information into a press-ready document, the press-ready document corresponding to the digital photography book and including at least two of crop marks, barcode information and customer order information; and
creating the press-ready document from the book information using the selected transform file.

164. The computer-readable medium of claim 163, wherein the book information is treated as a single object during the creating.

165. The computer-readable medium of claim 163, the receiving comprising:
detecting the presence of a file indicating the arrival of the book information, the file including information reflecting the storage location of the book information; and
retrieving the book information from the storage location.

166. The computer-readable medium of claim 163, the receiving comprising:
detecting that an arrival flag has been set, the arrival flag corresponding to the book information and indicating the arrival of the book information; and
retrieving the book information.

167. The computer-readable medium of claim 165, wherein the file is an arrival pointer file.

168. The computer-readable medium of claim 167, wherein the arrival pointer file comprises an indication of the transform file.

169. The computer-readable medium of claim 167, wherein the arrival pointer file comprises at least one of an internal order number, a partner order number, and a template identification.

170. The computer-readable medium of claim 165, the selecting comprising:
choosing the transform file based on information from the arrival pointer file.

171. The computer-readable medium of claim 163, the selecting comprising:
choosing the transform file based on a location where the book information was received.

172. The computer-readable medium of claim 163, the selecting comprising:
choosing the transform file based on a format associated with the book information.

173. The computer-readable medium of claim 163, wherein the transform file includes information specifying a size of the press-ready document.

174. The computer-readable medium of claim 163, wherein the transform file includes information specifying locations of crop marks.

175. The computer-readable medium of claim 163, wherein the transform file includes information specifying crop box size.

176. The computer-readable medium of claim 163, wherein the transform file includes information specifying locations of color bars.

177. The computer-readable medium of claim 163, wherein the transform file includes information specifying locations of page gutters.

178. The computer-readable medium of claim 163, wherein the transform file includes information specifying locations of barcodes.

179. The computer-readable medium of claim 163, wherein the transform file includes information specifying print type.

180. The computer-readable medium of claim 179, wherein the print type is simplex.

181. The computer-readable medium of claim 179, wherein the print type is duplex.

182. The computer-readable medium of claim 163, wherein the transform file is implemented in XML.

183. The computer-readable medium of claim 163, wherein the press-ready document further includes color bar information.

184. The computer-readable medium of claim 163, wherein the customer order information is located in a gutter area of each page in the press-ready document.

185. The computer-readable medium of claim 183, wherein the barcode information and color bar information are located on each page so that they are hidden within a spine of the digital photography book after the book has been completed.

186. The computer-readable medium of claim 163, the creating comprising:
reading the transform file; and
importing the book information into the press-ready document based on information from the transform file.

187. The computer-readable medium of claim 163, further comprising:
printing the press-ready document.

188. The computer-readable medium of claim 163, further comprising:
providing an indication that the press-ready document is ready.

189. The computer-readable medium of claim 188, the providing comprising:
creating a transporter pointer file indicating that the press-ready document is ready to be transported to a printing site.

190. The computer-readable medium of claim 188, the providing comprising:
setting a transporter flag indicating that the press-ready document is ready to be transported to a printing site.

191. The computer-readable medium of claim 188, the providing comprising:
creating an order pointer file indicating that the press-ready document is ready for further processing.

192. The computer-readable medium of claim 188, the providing comprising:
setting an order flag indicating that the press-ready document is ready for further processing.

193. The computer-readable medium of claim 189, further comprising:
detecting the presence of the transporter pointer file, the transporter pointer file including information reflecting the storage location of the press-ready document;
retrieving the press-ready document from the storage location; and
forwarding the press-ready document to a printing site.

194. The computer-readable medium of claim 193, the forwarding comprising:
selecting one of a plurality of printing sites; and
sending the press-ready document to the selected printing site.

195. The computer-readable medium of claim 194, wherein the selected printing site is chosen based on at least one of availability of press, time of day, shift capability, location of press, weather, and availability of delivery services.

196. The computer-readable medium of claim 193, further comprising:
verifying the press-ready document; and
printing the press-ready document based on a determination that the press-ready document passed verification.

197. The computer-readable medium of claim 196, the verifying comprising:
performing an error check on the press-ready document;
processing the press-ready document for printing based on a determination that the press-ready document passed the error check; and
creating a new document from the press-ready document based on a determination that the press-ready document was not properly processed.

198. The computer-readable medium of claim 197, the verifying further comprising:
based on a determination that the press-ready document failed the error check, designating the press-ready document as a bad press-ready document.

199. A computer-readable medium containing instructions for performing a method for producing a digital photography book, the method comprising:
receiving book information corresponding to a digital photography book;
selecting a transform file for use in transforming the book information into a press-ready document;
creating the press-ready document from the book information using the selected transform file;
verifying the press-ready document; and
printing the press-ready document based on a determination that the press-ready document passed verification.

200. The computer-readable medium of claim 199, wherein the book information is treated as a single object.

201. The computer-readable medium of claim 199, the receiving comprising:
detecting the presence of a file indicating the arrival of the book information, the file including information reflecting the storage location of the book information; and
retrieving the book information from the storage location.

202. The computer-readable medium of claim 199, the receiving comprising:
detecting that an arrival flag has been set, the arrival flag corresponding to the book information and indicating the arrival of the book information; and
retrieving the book information.

203. The computer-readable medium of claim 199, the selecting comprising:
choosing the transform file based on a location where the book information was received.

204. The computer-readable medium of claim 199, the selecting comprising:
choosing the transform file based on a format associated with the book information.

205. The computer-readable medium of claim 199, the creating comprising:
reading the transform file; and
importing the book information into the press-ready document based on information from the transform file.

206. The computer-readable medium of claim 199, the verifying comprising:
performing an error check on the press-ready document;
processing the press-ready document for printing based on a determination that the press-ready document passed the error check; and
creating a new document from the press-ready document based on a determination that the press-ready document was not properly processed.

207. The computer-readable medium of claim 206, the verifying further comprising:
based on a determination that the press-ready document failed the error check, designating the press-ready document as a bad press-ready document.

208. A computer-readable medium containing instructions for performing a method for producing a digital photography book, the method comprising:
receiving book information corresponding to a digital photography book;
pre-verifying the book information;
determining a type of the book information if the book information passed pre-verification; and
creating a press-ready document from the book information based on the determination.

209. The computer-readable medium of claim 208, the receiving comprising:
detecting the presence of a file indicating the arrival of the book information, the file including information reflecting the storage location of the book information; and
retrieving the book information from the storage location.

210. The computer-readable medium of claim 208, the receiving comprising:
detecting that an arrival flag has been set, the arrival flag corresponding to the book information and indicating the arrival of the book information; and
retrieving the book information.

211. The computer-readable medium of claim 208, the pre-verifying comprising:
spooling the book information;
determining whether the spooled book information has an error; and
storing the spooled book information as verified book information based on a determination that no error exists.

212. The computer-readable medium of claim 211, the pre-verifying further comprising:
when an error exists, storing the spooled book information as bad book information, and canceling an order for the digital photography book.

213. The computer-readable medium of claim 208, the determining comprising:
detecting verified book information in one of a plurality of folders; and
ascertaining the type of the book information based on in which folder the verified book information is located, wherein verified book information is stored in different folders dependent on page sizes associated with the verified book information.

214. The computer-readable medium of claim 208, the creating comprising:
selecting a transform file for use in transforming the book information into the press-ready document, the transform file being selected based on the type of the book information; and
constructing the press-ready document from the book information using the selected transform file.

215. The computer-readable medium of claim 214, the constructing comprising:
reading the transform file; and
importing the book information into the press-ready document based on information from the transform file.

216. The computer-readable medium of claim 208, further comprising:
providing an indication that the press-ready document is ready.

217. The computer-readable medium of claim 216, the providing comprising:
creating a transporter pointer file indicating that the press-ready document is ready to be transported to a printing site.

218. The computer-readable medium of claim 216, the providing comprising:
setting a transporter flag indicating that the press-ready document is ready to be transported to a printing site.

219. The computer-readable medium of claim 216, the providing comprising:
creating an order pointer file indicating that the press-ready document is ready for further processing.

220. The computer-readable medium of claim 216, the providing comprising:
setting an order flag indicating that the press-ready document is ready for further processing.

221. The computer-readable medium of claim 217, further comprising:
detecting the presence of the transporter pointer file, the transporter pointer file including information reflecting the storage location of the press-ready document;
retrieving the press-ready document from the storage location; and
forwarding the press-ready document to a printing site.

222. The computer-readable medium of claim 221, the forwarding comprising:
selecting one of a plurality of printing sites; and
sending the press-ready document to the selected printing site.

223. The computer-readable medium of claim 222, wherein the selected printing site is chosen based on at least one of availability of press, time of day, shift capability, location of press, weather, and availability of delivery services.

224. The computer-readable medium of claim 221, further comprising:
verifying the press-ready document; and
printing the press-ready document based on a determination that the press-ready document passed verification.

225. The computer-readable medium of claim 224, the verifying comprising:
performing an error check on the press-ready document;
processing the press-ready document for printing based on a determination that the press-ready document passed the error check;
creating a new document from the press-ready document based on a determination that the press-ready document was not properly processed.

226. The computer-readable medium of claim 225, the verifying further comprising:
based on a determination that the press-ready document failed the error check, designating the press-ready document as a bad press-ready document.

227. A computer-readable medium containing instructions for performing a method for producing a digital photography book, the method comprising:
receiving book information corresponding to a digital photography book;
determining a source of the book information;
extracting state information pertaining to the digital photography book from the book information based on the determination;
creating a book document from the book information using the extracted state information; and
creating a press-ready document from the book document using a transform file, wherein the transform file is used in transforming book documents into press-ready documents.

228. The computer-readable medium of claim 227, wherein the transform file includes information specifying locations of crop marks.

229. The computer-readable medium of claim 227, wherein the transform file includes information specifying crop box size.

230. The computer-readable medium of claim 227, wherein the transform file includes information specifying locations of color bars.

231. The computer-readable medium of claim 227, wherein the transform file includes information specifying locations of page gutters.

232. The computer-readable medium of claim 227, wherein the transform file includes information specifying locations of barcodes.

233. The computer-readable medium of claim 228, wherein the transform file includes information specifying print type.

234. The computer-readable medium of claim 233, wherein the print type is simplex.

235. The computer-readable medium of claim 233, wherein the print type is duplex.

236. The computer-readable medium of claim 227, wherein the transform file is implemented in a document markup language.

237. The computer-readable medium of claim 227, wherein the document marking language is extensible and supports user-defined fields.

238. The computer-readable medium of claim 227, wherein the press-ready document includes at least one of crop marks, barcode information, customer order information, and color bar information.

239. The computer-readable medium of claim 227, wherein the customer order information is located in a gutter area of each page in the press-ready document.

240. The computer-readable medium of claim 238, wherein the barcode information and color bar information are located on each page so that they are hidden within a spine of the digital photography book after the book has been completed.

241. The computer-readable medium of claim 227, the creating comprising:
reading the transform file; and
importing the book document into the press-ready document based on information from the transform file.

242. The computer-readable medium of claim 227, further comprising:
printing the press-ready document.

243. A computer-readable medium containing instructions for performing a method for producing a digital photography book, the method comprising:
receiving book information corresponding to a digital photography book;
transforming the book information into a first press-ready document;
performing an error check on the first press-ready document;
processing the first press-ready document for printing based on a determination that the first press-ready document passed the error check;
creating a new press-ready document from the first press-ready document based on a determination that the first press-ready document was not properly processed; and
printing the new press-ready document.

244. An apparatus for producing a digital photography book, comprising:
an interface operable to receive book information corresponding to a digital photography book; and
a book document generating module operable to select a transform file for use in transforming the book information into a press-ready document, the press-ready document corresponding to the digital photography book and including at least two of crop marks, barcode information and customer order information, and to create the press-ready document from the book information using the selected transform file.

245. A system for producing a digital photography book, comprising:
an interface operable to receive book information corresponding to a digital photography book;
a book document generating module operable to select a transform file for use in transforming the book information into a press-ready document, and create the press-ready document from the book information using the selected transform file;
a verification module operable to verify the press-ready document; and
a press operable to print the press-ready document based on a determination that the press-ready document passed verification.

246. An apparatus for producing a digital photography book, comprising:
an interface operable to receive book information corresponding to a digital photography book;
a pre-verification module operable to pre-verify the book information; and
a book document generating module operable to determine a type of the book information if the book information passed pre-verification, and create a press-ready document from the book information based on the determination.

247. An apparatus for producing a digital photography book, comprising:
an interface operable to receive book information corresponding to a digital photography book; and
a book document generating module operable to determine a source of the book information, extract state information pertaining to the digital photography book from the book information based on the determination, create a book document from the book information using the extracted state information, and create a press-ready document from the book document using a transform file, wherein the transform file is used in transforming book documents into press-ready documents.

248. A system for producing a digital photography book, comprising:
an interface operable to receive book information corresponding to a digital photography book;
a book document generating module operable to transform the book information into a first press-ready document;
a verification module operable to perform an error check on the first press-ready document, and create a new press-ready document from the first press-ready document based on a determination that the first press-ready document was not properly processed;
a raster image processor module operable to process the first press-ready document for printing based on a determination that the first press-ready document passed the error check; and
a press operable to print the new press-ready document.

249. A system for producing a digital photography book, comprising:
a network;
a plurality of clients each operable to generate book information that corresponds to a digital photography book;
pre-printing servers connected to the network, the pre-printing servers including: an interface operable to receive book information from one of the clients; and a book document generating module operable to select a transform file for use in transforming the book information into a press-ready document, and create the press-ready document from the book information using the selected transform file; and
a printing site connected to the network, the printing site operable to receive the press-ready document from the pre-printing servers and including a verification module operable to verify the press-ready document, the printing site further including a press operable to print the press-ready document based on a determination that the press-ready document passed verification.
